(19) United States
(12) Patent Application Publication
(10) Pub. No.: US 2025/0044212 A1
(43) Pub. Date: Feb. 6, 2025

(54) FLOW CYTOMETER, IMAGING DEVICE, POSITION DETECTION METHOD, AND PROGRAM

(71) Applicant: ThinkCyte K.K., Tokyo (JP)

(72) Inventors: Toru Imai, Tokyo (JP); Keiji Nakagawa, Tokyo (JP)

(73) Assignee: ThinkCyte K.K., Tokyo (JP)

(21) Appl. No.: 18/800,710

(22) Filed: Aug. 12, 2024

Related U.S. Application Data
(63) Continuation of application No. 18/700,652, filed on Apr. 11, 2024.

(51) Int. Cl. G01N 15/1409; G01N 15/14; G01N 15/1429

(52) U.S. Cl. CPC G01N 15/1409; G01N 15/1429; G01N 2015/1477; G01N 2015/1497

(57) ABSTRACT

A flow cytometer includes a microfluidic device, a light source, a photodetector, an information generation device, a calculation device, and a flow path position control device. In the microfluidic device, a first position detection line is arranged on a flow path, a second position detection line is arranged with a portion overlapping the first position detection line in a width direction, and a position detection distance, which is a distance between the first position detection line and the second position detection line in a length direction of the flow path, changes with a position in the width direction. The calculation device includes a time difference calculation unit configured to calculate a time difference between the time when the photodetector has detected a peak intensity of an optical signal at any one detection position on the first position detection line and the time when the photodetector has detected the peak intensity of the optical signal at any one detection position on the second position detection line and a position calculation unit configured to calculate the position of the observation object in the width direction on the basis of the time difference and a corresponding relationship between the time difference and the position in the width direction.

### DESCRIPTION

### Technical Field

The present invention relates to a flow cytometer, an imaging device, a position detection method, and a program.

### Background Art

Conventionally, a flow cytometry method in which the observation object is stained fluorescently and characteristics of the observation object is evaluated based on its total amount of fluorescence luminance and a flow cytometer using this flow cytometry method are known (for example, Patent Document 1). Moreover, fluorescence microscopes and imaging cytometers for evaluating fine particles such as cells and bacteria, which are observation objects, with images are known. However, it has been difficult to capture characteristics of two-dimensional spatial measurement targets, such as cell morphological information and the shape of intracellular organelles, by these measurement methods based on the total amount of fluorescence luminance or scattered light.

In flow cytometers or imaging cytometers, flow cytometers or imaging cytometers in which an observation object is irradiated with illumination light having a predetermined illumination pattern to detect the observation object have been developed and more detailed morphological information of the observation object can be acquired. Furthermore, by adopting a random structured illumination pattern as this illumination pattern, it becomes possible to shorten the length of the irradiation illumination pattern, and thus to speed up the measurement.

### CITATION LIST

### Patent Document

### [Patent Document 1]

Japanese Unexamined Patent Application, First Publication No. 2011-099848

### SUMMARY OF INVENTION

### Technical Problem

However, the detection of the observation object using a random structured illumination pattern is sensitive to positional deviation of a flow line. Here, the position deviation of the flow line indicates that a position of the observation object flowing with the fluid flowing through a flow path relatively deviates in a width direction of the flow path with respect to the structured illumination pattern. The width direction of the flow path can be represented, for example, as a direction perpendicular to both an optical axis of the illumination light irradiated to the flow path and a length direction in which the fluid flows. In the case of detection using a random structured illumination pattern, it has been necessary to ensure the reproducibility of data. On the other hand, it is significantly difficult to precisely control the flow line because it is affected by fluctuations in the fluid pressure or the like. Therefore, in a flow cytometer in which an observation object is illuminated with illumination light having a predetermined illumination pattern for its detection, it is particularly required to monitor the position deviation of the flow line in real time and to correct the position of the flow path with respect to the position deviation of the flow line. The position deviation of the flow line in question in the present invention is the deviation by about a pixel size of the structured illumination pattern, which is irradiated on the flow path, and it is that the flow line is approximately deviated by several micrometers in the width direction of the flow path.

The present invention has been made in view of the above points and provides a flow cytometer, an imaging device, a position detection method, and a program capable of detecting position deviation of a flow line.

### Solution to Problem

The present invention has been made to solve the above-described problems. According to an aspect of the present invention, there is provided a flow cytometer including a microfluidic device having a flow path through which an observation object can flow with a fluid, a light source configured to irradiate illumination light to the flow path, a photodetector configured to detect the intensity of an optical signal emitted from the observation object in a time series when the illumination light is irradiated to the observation object flowing through the flow path, an information generation device configured to generate optical information indicating any one or more of a shape, form, and structure of the observation object on the basis of the intensity of the optical signal detected by the photodetector, and a calculation device configured to calculate a position of the observation object in a width direction of the flow path on the basis of the time when the photodetector has detected a peak intensity of the optical signal, wherein, in the microfluidic device, a first position detection line, which is a group of a plurality of detection positions where the photodetector detects a position of the observation object and a position detection line having at least a length in the width direction, is arranged on the flow path, a second position detection line serving as the position detection line is arranged with a portion overlapping the first position detection line in the width direction, and a position detection distance, which is a distance between the first position detection line and the second position detection line in a length direction of the flow path, changes with a position in the width direction, wherein the calculation device includes: a time difference calculation unit configured to calculate a time difference between the time when the photodetector has detected the peak intensity of the optical signal at any one detection position on the first position detection line and the time when the photodetector has detected the peak intensity of the optical signal at any one detection position on the second position detection line; and a position calculation unit configured to calculate the position of the observation object in the width direction on the basis of the time difference calculated by the time difference calculation unit and a corresponding relationship between the time difference and the position in the width direction.

Moreover, according to an aspect of the present invention, the above-described flow cytometer further includes a flow path position control device configured to control a position of the flow path on the basis of a calculation result of the calculation device.

Moreover, according to an aspect of the present invention, in the flow cytometer, a third position detection line serving as the position detection line is arranged on the flow path, a fourth position detection line serving as the position detection line approximately parallel to the third position detection line is arranged at a flow rate measurement distance, which is a predetermined distance from the third position detection line, and has a portion overlapping the third position detection line in the width direction, and the calculation device further includes a flow rate calculation unit configured to calculate a flow rate of the fluid on the basis of the time when the photodetector has detected the peak intensity of the optical signal at any one detection position on the third position detection line, the time when the photodetector has detected the peak intensity of the optical signal at any one detection position on the fourth position detection line, and the flow rate measurement distance; and a position detection distance calculation unit configured to calculate the position detection distance corresponding to the position of the observation object in the width direction on the basis of the time difference calculated by the time difference calculation unit and the flow rate calculated by the flow rate calculation unit.

Moreover, according to an aspect of the present invention, the above-described flow cytometer further includes a spatial light modulation unit installed on an optical path between the light source and the photodetector and configured to structure either the illumination light or the optical signal.

Moreover, according to an aspect of the present invention, in the above-described flow cytometer, the light source irradiates the illumination light structured by the spatial light modulation unit installed on the optical path between the light source and the flow path to the flow path.

Moreover, according to an aspect of the present invention, in the above-described flow cytometer, the photodetector detects the intensity of the optical signal in a time series when the optical signal is structured by the spatial light modulation unit arranged on the optical path between the flow path and the photodetector.

Moreover, according to an aspect of the present invention, in the above-described flow cytometer, the position detection distance changes monotonically with the position in the width direction in relation to the position detection lines.

Moreover, according to an aspect of the present invention, in the above-described flow cytometer, the position detection line is a straight line.

Moreover, according to an aspect of the present invention, in the above-described flow cytometer, an angle between the first position detection line and the second position detection line is greater than or equal to a predetermined value.

Moreover, according to an aspect of the present invention, in the above-described flow cytometer, the position detection line is arranged according to the illumination light structured by the spatial light modulation unit.

Moreover, according to an aspect of the present invention, in the above-described flow cytometer, the position detection line is arranged according to the optical signal structured by the spatial light modulation unit.

Moreover, according to an aspect of the present invention, in the above-described flow cytometer, the calculation device further includes: a discrimination unit configured to discriminate the observation object on the basis of the optical information generated by the information generation device; and a position determination unit configured to determine whether or not the position in the width direction calculated by the position calculation unit is within a predetermined range in the width direction, and the discrimination unit designates the observation object flowing within the predetermined range as a discrimination target on the basis of a determination result of the position determination unit.

Moreover, according to an aspect of the present invention, in the above-described flow cytometer, the discrimination unit discriminates the observation object on the basis of an inference model created when a relationship between a learning observation object and optical information for the learning observation object is learned and the optical information generated by the information generation device, and the learning observation object is an observation object flowing within the predetermined range.

Moreover, according to an aspect of the present invention, there is provided an imaging device including: the above-described flow cytometer; and an image generation device including an image generation unit configured to generate an image of the observation object on the basis of the optical information generated by the information generation device.

Moreover, according to an aspect of the present invention, there is provided a method of calculating a position of an observation object in a width direction in a flow cytometer including a microfluidic device having a flow path through which the observation object can flow with a fluid, a light source configured to irradiate illumination light to the flow path, a photodetector configured to detect the intensity of an optical signal emitted from the observation object in a time series when the illumination light is irradiated to the observation object flowing through the flow path, an information generation device configured to generate optical information indicating any one or more of a shape, form, and structure of the observation object on the basis of the intensity of the optical signal detected by the photodetector, and a calculation device configured to calculate the position of the observation object in the width direction of the flow path on the basis of the intensity of the optical signal detected by the photodetector, the method including: a time difference calculation process of calculating a time difference between the time when the photodetector has detected the peak intensity of the optical signal at any one detection position on a first position detection line, which is arranged on the flow path and is a group of a plurality of detection positions where the photodetector detects the position of the observation object and a position detection line having at least a length in the width direction, and the time when the photodetector has detected the peak intensity of the optical signal at any one detection position on a second position detection line serving as the position detection line arranged with a portion overlapping the first position detection line in the width direction, wherein a position detection distance, which is a distance between the first position detection line and the second position detection line in a length direction of the flow path, changes with a position in the width direction; and a position calculation process of calculating the position of the observation object in the width direction on the basis of the time difference calculated in the time difference calculation process and a corresponding relationship between the time difference and the position in the width direction.

Moreover, according to an aspect of the present invention, there is provided a program for causing a computer, which calculates a position of an observation object in a width direction in a flow cytometer including a microfluidic device having a flow path through which the observation object can flow with a fluid, a light source configured to irradiate illumination light to the flow path, a photodetector configured to detect the intensity of an optical signal emitted from the observation object in a time series when the illumination light is irradiated to the observation object flowing through the flow path, an information generation device configured to generate optical information indicating any one or more of a shape, form, and structure of the observation object on the basis of the intensity of the optical signal detected by the photodetector, and a calculation device configured to calculate the position of the observation object in the width direction of the flow path on the basis of the intensity of the optical signal detected by the photodetector, to execute: a time difference calculation step of calculating a time difference between the time when the photodetector has detected the peak intensity of the optical signal at any one detection position on a first position detection line, which is arranged on the flow path and is a group of a plurality of detection positions where the photodetector detects the position of the observation object and a position detection line having at least a length in the width direction, and the time when the photodetector has detected the peak intensity of the optical signal at any one detection position on a second position detection line serving as the position detection line arranged with a portion overlapping the first position detection line in the width direction, wherein a position detection distance, which is a distance between the first position detection line and the second position detection line in a length direction of the flow path, changes with a position in the width direction; and a position calculation step of calculating the position of the observation object in the width direction on the basis of the time difference calculated in the time difference calculation step and a corresponding relationship between the time difference and the position in the width direction.

### Advantageous Effects of Invention

According to the present invention, it is possible to detect position deviation of a flow line.

### BRIEF DESCRIPTION OF DRAWINGS

FIG. 1 is a diagram showing an example of a flow cytometer according to a first embodiment of the present invention.

FIG. 2 is a diagram showing an example of a spatial light modulation unit according to the first embodiment of the present invention.

FIG. 3 is a diagram showing an example of position detection lines according to the first embodiment of the present invention.

FIG. 4 is a diagram showing an example of a configuration of a calculation unit according to the first embodiment of the present invention.

FIG. 5 is a diagram showing an example of a position calculation process according to the first embodiment of the present invention.

FIG. 6 is a diagram showing an example of a measured signal according to the first embodiment of the present invention.

FIG. 7 is a diagram showing an example of position detection lines according to Modified Example 1 of the first embodiment of the present invention.

FIG. 8 is a diagram showing an example of a measured signal according to

Modified Example 1 of the first embodiment of the present invention.

FIG. 9 is a diagram showing an example of position detection lines according to Modified Example 2 of the first embodiment of the present invention.

FIG. 10 is a diagram showing an example of a measured signal according to Modified Example 2 of the first embodiment of the present invention.

FIG. 11 is a diagram showing an example of position detection lines according to Modified Example 3 of the first embodiment of the present invention.

FIG. 12 is a diagram showing an example of a measured signal according to Modified Example 3 of the first embodiment of the present invention.

FIG. 13 is a diagram showing an example of position detection lines according to Modified Example 4 of the first embodiment of the present invention.

FIG. 14 is a diagram showing another example of position detection lines according to Modified Example 4 of the first embodiment of the present invention.

FIG. 15 is a diagram showing yet another example of position detection lines according to Modified Example 4 of the first embodiment of the present invention.

FIG. 16 is a diagram showing an example of position detection lines according to Modified Example 5 of the first embodiment of the present invention.

FIG. 17 is a diagram showing an example of position detection lines according to Modified Example 6 of the first embodiment of the present invention.

FIG. 18 is a diagram showing an example of a flow cytometer according to a modified example of a second embodiment of the present invention.

FIG. 19 is a diagram showing an example of a flow cytometer according to a third embodiment of the present invention.

FIG. 20 is a diagram showing an example of a flow cytometer according to a fourth embodiment of the present invention.

FIG. 21 is a diagram showing an example of a calculation unit according to the fourth embodiment of the present invention.

FIG. 22 is a diagram showing an example of a position calculation process according to the fourth embodiment of the present invention.

FIG. 23 is a diagram showing an example of a configuration of a calculation unit according to a fifth embodiment of the present invention.

FIG. 24 is a diagram showing an example of an area according to the fifth embodiment of the present invention.

FIG. 25 is a diagram showing an example of an area of cells for learning according to the fifth embodiment of the present invention.

FIG. 26 is a diagram showing an example of a cell discrimination process according to the fifth embodiment of the present invention.

### DESCRIPTION OF EMBODIMENTS

### First Embodiment

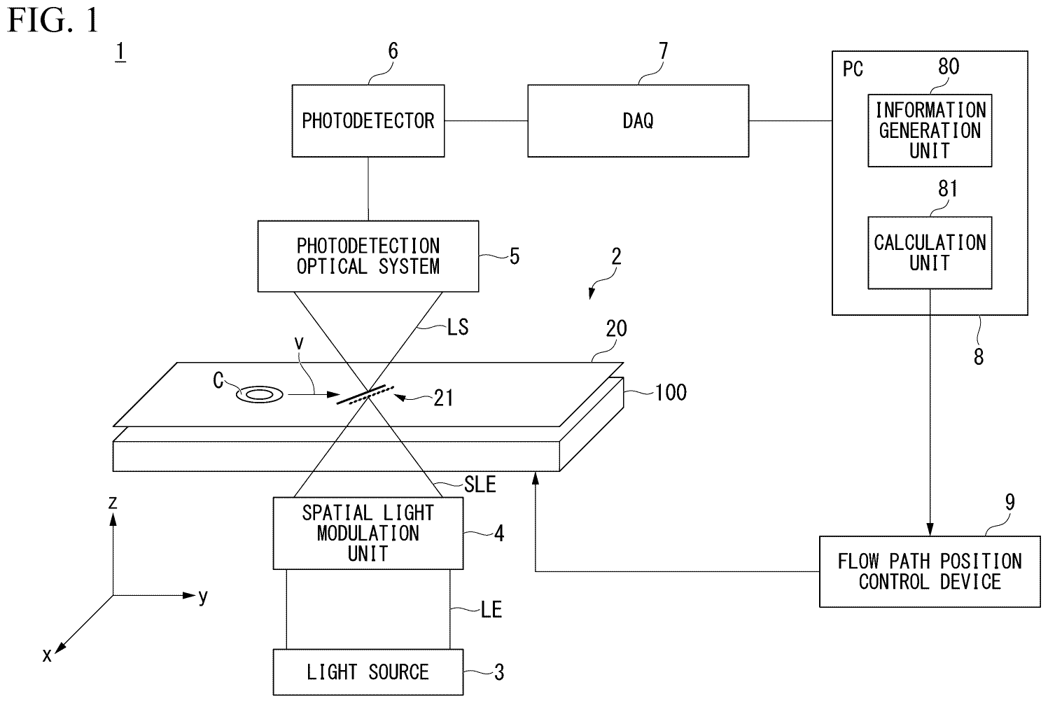

Hereinafter, embodiments of the present invention will be described in detail with reference to the drawings. FIG. 1 is a diagram showing an example of a flow cytometer 1 according to the present embodiment. The flow cytometer 1 includes a microfluidic device 2, a light source 3, a spatial light modulation unit 4, a photodetection optical system 5, a photodetector 6, a data acquisition (DAQ) device 7, a personal computer (PC) 8, and a flow path position control device 9.

The microfluidic device 2 includes a flow path 20 through which a cell C can flow with a fluid. A flow rate v of the fluid flowing through the flow path 20 does not depend on the type of cell C to be flowed or individual differences. Moreover, the microfluidic device 2 allows a plurality of cells to sequentially flow through the flow path 20, but the number of cells flowing through an irradiation position of the flow path 20 at a time is one. The cell C is an example of an observation object. Also, the observation object is not limited to the cell C and may be fine particles or the like as another example.

Here, an XYZ coordinate system is shown as a three-dimensional orthogonal coordinate system in FIG. 1. In the present embodiment, an x-axis direction is the width direction of the flow path 20. Moreover, a y-axis direction is a length direction of the flow path 20. A z-axis direction is a direction perpendicular to the flow path 20 and is a height or depth direction of the flow path 20. The flow of the fluid in the flow path 20 moves the cell C in a +y-direction in the y-axis direction. In other words, the width direction of the flow path 20 is a direction perpendicular to the flow line of the fluid flowing with the cell C.

The light source 3 and the spatial light modulation unit 4 function as structured illumination. This structured illumination irradiates the flow path 20 with structured illumination light SLE, which is illumination light that has been structured, as described below.

Illumination light LE emitted by the light source 3 is irradiated through the spatial light modulation unit 4 to the flow path 20 as a structured illumination light SLE. The illumination light LE emitted by the light source 3 may be coherent light or incoherent light. In the present embodiment, the illumination light LE emitted by the light source 3 is coherent light as an example.

The spatial light modulation unit 4 is arranged on the optical path between the light source 3 and the photodetector 6. In the present embodiment, the spatial light modulation unit 4 is arranged on the optical path of the illumination light LE irradiated from the light source 3 to the flow path 20. The configuration of this arrangement is also referred to as the configuration of structured illumination. The structured illumination irradiates structured illumination light SLE, which is illumination light LE structured by the spatial light modulation unit 4, to the flow path 20. Here, the structured illumination forms an image of the structured illumination light SLE as a structural illumination pattern 21 in the flow path 20. Details of the structural illumination pattern 21 will be described below.

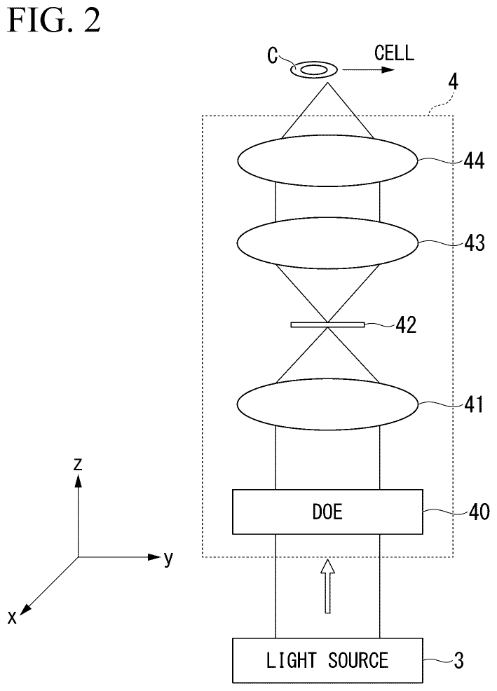

Here, the spatial light modulation unit 4 will be described with reference to FIG. 2. FIG. 2 is a diagram showing an example of the spatial light modulation unit 4 according to the present embodiment. The spatial light modulation unit 4 includes a spatial light modulator 40, a first lens 41, a spatial filter 42, a second lens 43, and an objective lens 44. In the spatial light modulation unit 4, the spatial light modulator 40, the first lens 41, the spatial filter 42, the second lens 43, and the objective lens 44 are arranged in that order on an optical path between the light source 3 and the photodetector 6 from the side close to the light source 3.

The spatial light modulator 40 structures incident light. Structuring the incident light means modulating optical characteristics of the incident light for each of a plurality of areas included in an incident surface of the incident light. The spatial light modulator 40 is an optical element that modulates the optical characteristics of the incident light by changing the spatial distribution of the incident light by means of a calculated microstructure. The spatial light modulator 40 allows light to be irradiated by controlling the pattern of light irradiation. A surface of the spatial light modulator 40 on which the light is incident has a plurality of areas and the optical characteristics of the illumination light LE are individually modulated in the plurality of areas through which it passes. That is, in the light transmitted through the spatial light modulator 40, the optical characteristics of the transmitted light are changed so that they are different from each other in a plurality of areas with respect to the optical characteristics of the incident light. Here, the optical characteristics are, for example, the characteristics of light related to any one or more of the intensity, wavelength, phase, and polarization state. Also, the optical characteristics are not limited to these. The spatial light modulator 40 includes, for example, a diffractive optical element (DOE), a spatial light modulator (SLM), and a digital mirror device (DMD: digital micromirror device). Also, when the illumination light LE emitted by the light source 3 is incoherent light, the spatial light modulator 40 is a DMD.

In the following description, a position to which the structured illumination light SLE is irradiated in the flow path 20 is also referred to as an irradiation position. In the present embodiment, the irradiation position corresponds to the areas to which light is transmitted among the plurality of areas included in the spatial light modulator 40. Also, in the following description, the areas provided in the spatial light modulation unit 4 where light is transmitted are referred to as light transmission areas. The shape and size of this light transmission areas are identical for those of the light transmission area provided in the spatial light modulator 40. The shape of the light transmission areas is a square as an example. This square has one side of a length equal in the light transmission areas provided in the spatial light modulator 40. A cell C passing through the irradiation position emits light according to fluorescent molecules excited by the structured illumination light SLE. Fluorescence from this light emission is an example of an optical signal LS. The optical signal LS includes transmitted light in which the structured illumination light SLE is transmitted through the cell C, scattered light in which the structured illumination light SLE is scattered by the cell C, and interference light between the structured illumination light SLE and other light.

Also, the shape and size of the light transmission areas are not limited to a square as long as they are identical within the light transmission areas of the spatial light modulator 40, and the size can be freely changed. The shape of the light transmission area may be another polygon, a circle, or the like.

The first lens 41 collects the structured illumination light SLE transmitted through the spatial light modulator 40 on the spatial filter 42.

The spatial filter 42 makes the intensity distribution of the structured illumination light SLE closer to a Gaussian distribution by removing a component corresponding to spatially changing noise from the structured illumination light SLE collected by the first lens 41.

The second lens 43 makes the structured illumination light SLE from which noise is removed by the spatial filter 42 into parallel light.

The objective lens 44 collects the structured illumination light SLE which is collimated by the second lens 43 and forms an image at an irradiation position of the flow path 20.

Also, the objective lens 44 may be a dry objective lens or an immersion objective lens. The immersion objective lens is an oil immersion lens, a water immersion lens, or the like.

Description of the configuration of the flow cytometer 1 continues with reference back to FIG. 1.

The photodetection optical system 5 is an optical mechanism for forming an image of the cell C on the photodetector 6 and includes an image-forming lens in its configuration. The photodetection optical system 5 collects the optical signal LS from the cell C with the image-forming lens and the photodetector 6 detects the optical signal LS. The optical signal LS from the cell C is, for example, fluorescence, transmitted light, scattered light, or interference light. The image-forming lens included in the photodetection optical system 5 is preferably arranged at a position where an image of the optical signal LS is formed on the photodetector 6, but it is only necessary to arrange the image-forming lens at a position where a sufficient amount of light is collected on the photodetector 6. In addition to the image-forming lens, the photodetection optical system 5 may include a dichroic mirror and a wavelength-selective filter.

The photodetector 6 collects the optical signal LS emitted by the cell C with the photodetection optical system 5 and detects the optical signal LS. Here, the photodetector 6 detects the optical signal and converts the optical signal into an electrical signal. The photodetector 6 is a photomultiplier tube (PMT) as an example. The photodetector 6 detects the optical signal in a time series. The photodetector 6 may be a single sensor or a multi-sensor.

The DAQ device 7 converts each of electrical signal pulses output by the photodetector 6 into electronic data. The electronic data includes a set of time and the intensity of the electrical signal pulse. The DAQ device 7 is an oscilloscope as an example.

The PC 8 includes an information generation unit 80 and a calculation unit 81.

The information generation unit 80 generates optical information indicating morphological information of the cell C on the basis of the electronic data output from the DAQ device 7. The morphological information of the cell C is any one or more of a shape, form, and structure of the cell C. The information generation unit 80 stores the generated optical information. As an example, the optical information is information indicating a time-series change in the intensity of the optical signal LS from the cell C by a waveform. This waveform corresponds to the morphological information of the cell C and the optical information can be used to identify the cell C. As another example, the optical information is also used as training data when a relationship between the morphological information of the cell C and a waveform signal is learned in machine learning and identification of the cell C is performed from the waveform signal measured at the time of inference using a inference model obtained by supervised learning.

The calculation unit 81 calculates a position x of the cell C in the width direction of the flow path 20 on the basis of the temporal changes in the intensity of the optical signal LS detected by the photodetector 6. Details of a configuration and calculation process of the calculation unit 81 will be described below. Also, in the following description, calculating the position x of the cell C in the width direction of the flow path 20 on the basis of the temporal changes in the intensity of the optical signal LS detected by the photodetector 6 is also referred to as measuring the position x.

The information generation unit 80 is an example of an information generation device for generating optical information indicating any one or more of the shape, form, and structure of the observation object on the basis of the temporal changes in the intensity of the optical signal detected by the photodetector. The calculation unit 81 is an example of a calculation device for measuring the position x of the observation object on the basis of temporal changes in the intensity of the optical signal detected by the photodetector. Although an example in which the information generation device and the calculation device are integrated as the PC 8 will be described in the present embodiment, the present invention is not limited thereto. The information generation device and the calculation device may be provided as separate devices (for example, PCs).

The flow path position control device 9 controls a position of the flow path 20 on the basis of a calculation result of the calculation unit 81 of the PC 8. When the calculation result, which is the position x of a cell C in the width direction of the flow path 20, deviates from the reference position, the flow path position control device 9 causes the position of the flow path 20 to move so that this position x matches the reference position. Here, the reference position is a flow line center at the start of measurement as an example. The flow line center at the start of the measurement is determined by measuring in advance the position of the center of the pathway of the cells C in the width direction of the flow path 20 at the start of the measurement.

The flow path position control device 9 moves the position of the flow path 20 to a position more suitable for measurement by controlling a position of an automatic stage 100 on which the flow path 20 is placed. The automatic stage 100 is a piezo stage as an example. The flow path position control device 9 controls the automatic stage 100, which is a piezo stage, via a piezo actuator (not shown).

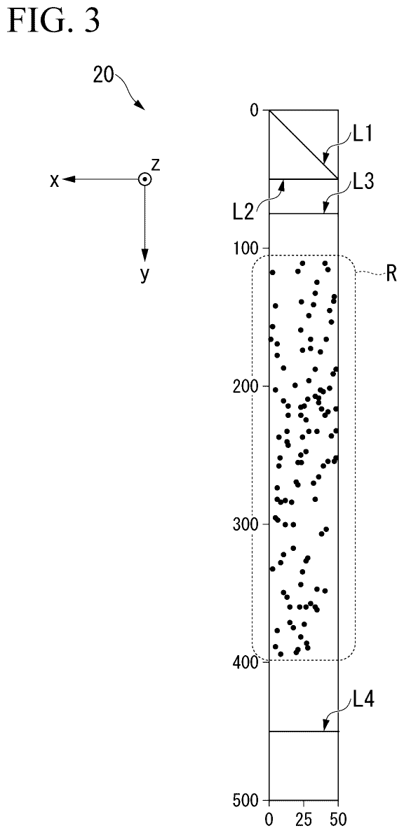

Next, a position detection line L arranged in the flow path 20 will be described with reference to FIG. 3. In the present embodiment, the position detection lines L are included in the structural illumination pattern 21 shown in FIG. 1 and are arranged on the flow path 20. FIG. 3 is a diagram showing an example of the position detection line L according to the present embodiment. In FIG. 3, the flow path 20 seen in the −z-direction of the z-axis direction is shown. In the following description, the flow path 20 seen from the +z-direction to the −z-direction in the z-axis direction may simply be referred to as the flow path 20 seen in the z-axis direction or the like.

In the flow path 20, a first position detection line L1, a second position detection line L2, a third position detection line L3, and a fourth position detection line L4 are arranged as position detection lines L.

The position detection line L is a group of a plurality of detection positions for which the photodetector 6 measures the position x of the cell C. When the cell C passes through a detection position of the flow path, the optical signal LS emitted from the cell C is detected by the photodetector 6. That is, the detection position is a position where the photodetector 6 detects the intensity of the optical signal LS. The detection position included in the position detection line L is used to calculate the position x of the cell C in the width direction of the flow path 20 by the calculation unit 81. The position detection line L has at least a length in the width direction of the flow path 20. Having a length in the width direction of the flow path 20 means having a length when projected in the width direction, i.e., in the x-axis direction. In the present embodiment, as shown in FIG. 3, the position detection line Lis a straight line.

Moreover, the flow path 20 has a detection area R. The detection area R is an area in which a plurality of detection positions are randomly arranged for the photodetector 6 to detect optical information related to the morphological information of the cell C. A randomly arranged pattern of structured illumination is irradiated at the irradiation position of the flow path 20 and the optical signal LS emitted when the cell C passes through the position of the detection area R of the flow path is detected by the photodetector 6 to obtain optical information related to the morphological information of the cell C. That is, the plurality of detection positions arranged in the detection area R are used for the detection of the cell C from which the information generation unit 80 generates the optical information indicating the form of the cell C. The information generation unit 80 generates the optical information on the basis of a random pattern made by the arrangement of the detection positions arranged in the detection area R.

A detection position corresponds to an irradiation position that is a position at which the above-described structured illumination light SLS is irradiated on the flow path 20 seen in the z-axis direction. As described above, the irradiation position corresponds to a light transmission area in the spatial light modulator 40, which is a spatial filter.

The first position detection line L1 and the second position detection line L2 are used to measure the position x of the cell C in the width direction of the flow path 20. On the other hand, the third position detection line L3 and the fourth position detection line L4 are used to measure the flow rate v of the fluid flowing through the flow path 20. Using the arrangement of FIG. 3 as an example, the arrangement of the first position detection line L1, the second position detection line L2, the third position detection line L3, and the fourth position detection line L4 on the flow path 20 will be further described.

The first position detection line L1 and the second position detection line L2 are arranged further upstream along the flow path 20 (in the −y-direction of the y-axis direction) than the detection area R. The second position detection line L2 is arranged further downstream along the flow path 20 (in the +y-direction of the y-axis direction) than the first position detection line L1.

The third position detection line L3 and the fourth position detection line L4 are arranged further downstream along the flow path 20 (in the +y-direction of the y-axis direction) than the first position detection line L1 and the second position detection line L2. The third position detection line L3 is arranged further upstream along the flow path 20 (in the −y-direction of the y-axis direction) than the detection area R. The fourth position detection line L4 is arranged further downstream along the flow path 20 (in the +y-direction of the y-axis direction) than the third position detection line L3 in a state in which the detection area R is sandwiched between the third position detection line L3 and the fourth position detection line L4.

The first position detection line L1 is arranged to be inclined by a predetermined angle with respect to the width direction (the x-axis direction) of the flow path 20. Here, the predetermined angle is 45 degrees as an example. The second position detection line L2 is arranged parallel to the width direction (the x-axis direction) of the flow path 20.

Here, the second position detection line L2 is arranged with a portion overlapping the first position detection line L1 in the width direction of the flow path 20. The second position detection line L2 has the portion overlapping the first position detection line L1 in the width direction of the flow path 20 means that there is an overlapping portion between the line segment obtained by projecting the first position detection line L1 in the x-axis direction and the line segment obtained by projecting the second position detection line L2 in the x-axis direction.

Moreover, the distance in the length direction of the flow path 20 between the first position detection line L1 and the second position detection line L2 changes with the position in the width direction of the flow path 20. The distance in the length direction of the flow path 20 between the first position detection line L1 and the second position detection line L2 corresponds to the position in the width direction of the flow path 20 on a one-to-one basis. In the following description, the distance in the length direction of the flow path 20 between the first position detection line L1 and the second position detection line L2 may be referred to as a position detection distance D12.

The first position detection line L1 and the second position detection line L2 are arranged so that the position detection distance D12 changes monotonically with respect to the x-axis. In FIG. 3, as an example, as the value of the x-axis coordinate changes from 0 micrometers to 50 micrometers, the position detection distance D12 is monotonically reduced from 50 micrometers to 0 micrometers. Also, the first position detection line L1 and the second position detection line L2 may be arranged so that the position detection distance D12 increases monotonically with respect to the x-axis.

As described above, the position detection distance D12 corresponds to the position in the width direction of the flow path 20 on a one-to-one basis and the position x of the cell C in the width direction of the flow path 20 is calculated on the basis of a corresponding relationship between the position detection distance D12 and the position in the width direction of the flow path 20 in the flow cytometer 1. Here, a time difference between time t1 when the photodetector 6 has detected the peak intensity of the optical signal at any detection position on the first position detection line L1 and time t2 when the photodetector 6 has detected the peak intensity of the optical signal at any detection position on the second position detection line L2 is referred to as a time difference τ. In the flow cytometer 1, the position detection distance D12 corresponding to position x is calculated on the basis of the time difference τ and the flow rate v of the fluid flowing through the flow path 20. Also, a process of detecting the optical signal LS emitted from the cell C passing through the detection position by the photodetector 6 and detecting the passage of the cell C as a waveform of the optical signal is represented as a process of detecting the peak of the optical signal at the detection position. Although the example in which the passage of the cell C is detected at the peak of the optical signal will be described below, it is possible to detect the passage of the cell C according to the position where the waveform rises or the position where the intensity of the optical signal shows a predetermined threshold value or more.

In the present embodiment, as an example, when the position x of the cell C in the width direction of the flow path 20 deviates in the +x-direction of the x-axis, the time difference τ increases monotonically in accordance with this deviation.

The third position detection line L3 is arranged parallel to the width direction (the x-axis direction) of the flow path 20. The fourth position detection line L4 is substantially parallel to the third position detection line L3 and is arranged at a predetermined distance from the third position detection line L3. The fourth position detection line L4 is arranged with a portion overlapping the third position detection line L3 in the width direction of the flow path 20. In the following description, a distance between the third position detection line L3 and the fourth position detection line L4 is referred to as a flow rate measurement distance D34.

Here, a time difference between time t3 when the photodetector 6 has detected the peak intensity of the optical signal at any detection position on the third position detection line L3 and time t4 when the photodetector 6 has detected the peak intensity of the optical signal at any detection position on the fourth position detection line L4 is referred to as a time difference dt34. In the flow cytometer 1, the flow rate v is measured on the basis of the time difference dt34 and the flow rate measurement distance D34.

Although the arrangement of the first position detection line L1, the second position detection line L2, the third position detection line L3, and the fourth position detection line L4 has been described above with reference to FIG. 3, the arrangement of the position detection lines L is not limited thereto. For example, the first position detection line L1 and the second position detection line L2 may be arranged further downstream along the flow path 20 (in the +y-direction of the y-axis direction) than the detection area R. The second position detection line L2 may be arranged further upstream along the flow path 20 (in the −y-direction of the y-axis direction) than the first position detection line L1.

Moreover, the fourth position detection line L4 may be arranged further upstream (in the −y-direction of the y-axis direction) than the detection area R if it is further downstream along the flow path 20 (in the +y-direction of the y-axis direction) than the third position detection line L3. That is, both the third position detection line L3 and the fourth position detection line L4 may be arranged further upstream (in the −y-direction of the y-axis direction) than the detection area R. Moreover, both the third position detection line L3 and the fourth position detection line L4 may be arranged further downstream (in the ty-direction of the y-axis direction) than the detection area R.

Furthermore, the third position detection line L3 may be arranged further upstream (in the −y-direction of the y-axis direction) than the first position detection line L1. Moreover, both the third position detection line L3 and the fourth position detection line L4 may be arranged further upstream (in the −y-direction of the y-axis direction) than the first position detection line L1. Furthermore, both the third position detection line L3 and the fourth position detection line L4 may be arranged at a position between the first position detection line L1 and the second position detection line L2 or either the third position detection line L3 or the fourth position detection line L4 may be arranged at a position between the first position detection line L1 and the second position detection line L2.

For example, the third position detection line L3, the first position detection line L1, the second position detection line L2, and the fourth position detection line L4 may be provided in that order from the upstream side, the first position detection line L1, the third position detection line L3, the second position detection line L2, and the fourth position detection line L4 may be provided in that order from the upstream side, or the first position detection line L1, the third position detection line L3, the fourth position detection line L4, and the second position detection line L2 may be provided in that order from the upstream side.

Also, the longer flow rate measurement distance D34 is preferable to increase the accuracy of the measurement of the flow rate v. That is, the third position detection line L3 and the fourth position detection line L4 are preferably arranged with a long flow rate measurement distance D34.

In the present embodiment, the position detection line Lis arranged without any gap in the width direction of the flow path 20. That is, the position detection line L has a length in the width direction of the flow path 20 equal to the width of the flow path 20.

Moreover, in the present embodiment, the two position detection lines L (the first position detection line L1 and the second position detection line L2) for measuring the position x of the cell C in the width direction of the flow path 20 are in contact at one end. That is, the position detection distance D12 is zero at one end.

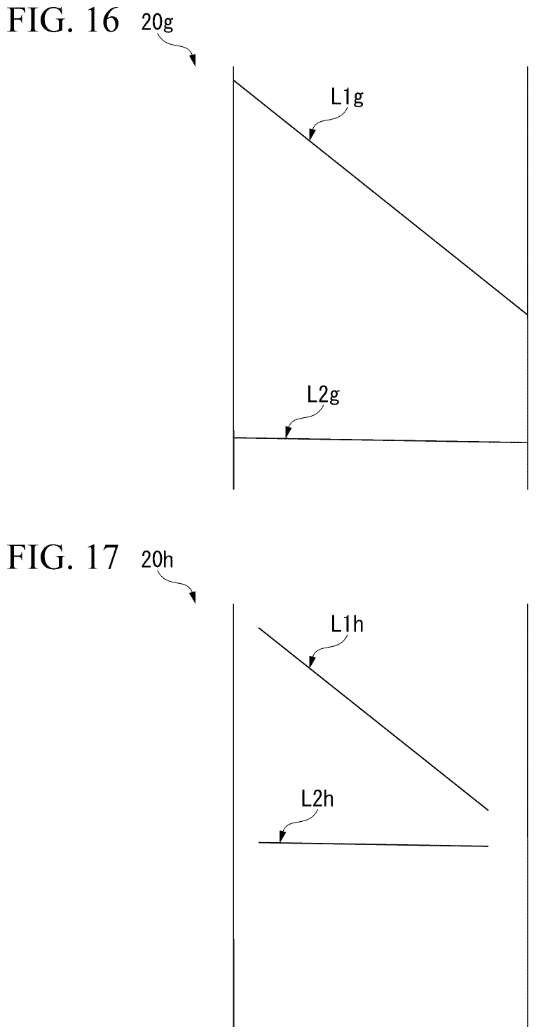

Also, as shown in the example of FIG. 16 to be described below, the position detection distance D12 may not be zero at one end. That is, the first position detection line L1 and the second position detection line L2 may not be in contact at either one of both ends. Moreover, the position detection distance D12 does not have to be zero at one end of the first position detection line L1 and the second position detection line L2 as long as it changes monotonically with respect to the x-axis. That is, the first position detection line L1 and the second position detection line L2 may have an intersection point other than one end.

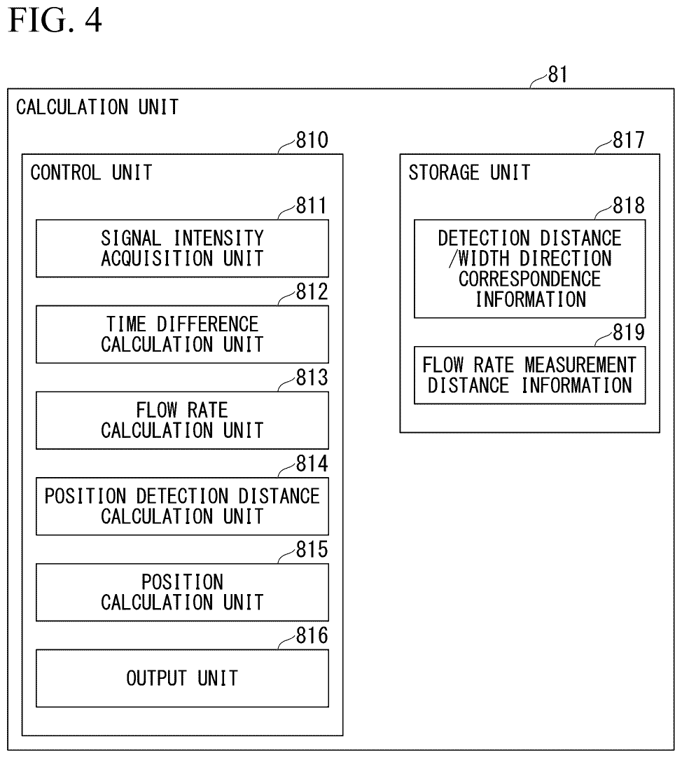

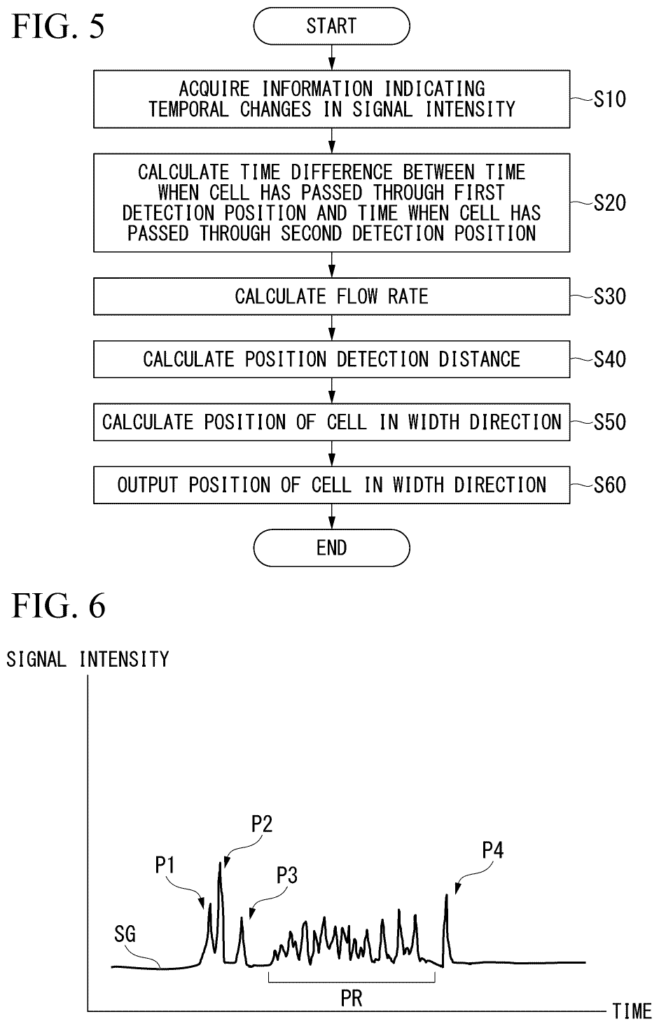

Next, details of a configuration and position calculation process of the calculation unit 81 will be described with reference to FIGS. 4 and 5.

FIG. 4 is a diagram showing an example of the configuration of the calculation unit 81 according to the present embodiment. The calculation unit 81 includes a control unit 810 and a storage unit 817.

The control unit 810 includes, for example, a central processing unit (CPU), a graphics processing unit (GPU), a field-programmable gate array (FPGA), and the like, and performs various calculations and information exchange. The control unit 810 includes a signal intensity acquisition unit 811, a time difference calculation unit 812, a flow rate calculation unit 813, a position detection distance calculation unit 814, a position calculation unit 815, and an output unit 816. Each of the signal intensity acquisition unit 811, the time difference calculation unit 812, the flow rate calculation unit 813, the position detection distance calculation unit 814, the position calculation unit 815, and the output unit 816 is a module implemented by, for example, a CPU reading a program from a read-only memory (ROM) and executing a process.

The signal intensity acquisition unit 811 acquires electronic data SD output from the DAQ device 7. The electronic data SD is electronic data indicating the signal intensity of the optical signal LS detected by the photodetector 6 at each time. In the following description, acquiring the electronic data SD is also referred to as acquiring a signal. Moreover, the electronic data indicating temporal changes in the signal intensity of the optical signal LS as a waveform is referred to as a measured signal SG.

The time difference calculation unit 812 calculates the time difference τ between time t1 when the photodetector 6 has detected the passage of the cell C as the peak intensity of the optical signal LS at any detection position on the first position detection line L1 and time t2 when the photodetector 6 has detected the passage of the cell as the peak intensity of the optical signal at any detection position on the second position detection line L2 on the basis of the electronic data SD acquired by the signal intensity acquisition unit 811.

The flow rate calculation unit 813 calculates the flow rate v on the basis of the time difference dt34 between time t3 when the photodetector 6 has detected the passage of the cell C as the peak intensity of the optical signal LS at any detection position on the third position detection line L3 and time t4 when the photodetector 6 has detected the passage of the cell as the peak intensity of the optical signal at any detection position on the fourth position detection line L4, which is calculated on the basis of the electronic data SD acquired by the signal intensity acquisition unit 811, and flow rate measurement distance information 819. The flow rate measurement distance information 819 is information indicating the flow rate measurement distance D34.

The position detection distance calculation unit 814 calculates the position detection distance D12 corresponding to the position x on the basis of the time difference τ calculated by the time difference calculation unit 812 and the flow rate v calculated by the flow rate calculation unit 813.

The position calculation unit 815 calculates the position x of the cell C in the width direction of the flow path 20 on the basis of the position detection distance D12 corresponding to the position x calculated by the position detection distance calculation unit 814 and detection distance/width direction correspondence information 818. Here, the detection distance/width direction correspondence information 818 is information indicating a corresponding relationship between the position detection distance D12 and the position x in the width direction of the flow path 20.

The output unit 816 outputs the position x of the cell C in the width direction of the flow path 20 calculated by the position calculation unit 815 to the flow path position control device 9.

The storage unit 817 stores the detection distance/width direction correspondence information 818 and the flow rate measurement distance information 819. As an example, the detection distance/width direction correspondence information 818 is two-dimensional tabular data consisting of rows and columns in which a value of the position in the width direction of the flow path 20 is stored for each position detection distance. The detection distance/width direction correspondence information 818 is generated in advance on the basis of the arrangement of the first position detection line L1 and the second position detection line L2 in the flow path 20. The flow rate measurement distance information 819 is generated in advance on the basis of the arrangement of the third position detection line L3 and the fourth position detection line L4 in the flow path 20.

FIG. 5 is a diagram showing an example of a position calculation process according to the present embodiment. The position calculation process is a process in which the calculation unit 81 calculates the position x of the cell C in the width direction of the flow path 20.

Step S10: The signal intensity acquisition unit 811 acquires the electronic data SD output from the DAQ device 7 as a measured signal SG indicating temporal changes in the signal intensity as a waveform.

Here, the measured signal SG will be described with reference to FIG. 6. FIG. 6 is an example of the measured signal SG according to the present embodiment. The measured signal SG is electronic data indicating the temporal changes in the signal intensity of the optical signal LS detected by the photodetector 6 as a waveform.

A first peak P1 at time t1 corresponds to an optical signal detected when the cell C passes through the first position detection line L1. A second peak P2 at time t2 corresponds to an optical signal detected when the cell C passes through the second position detection line L2. A third peak P3 at time t3 corresponds to an optical signal detected when the cell C passes through the third position detection line L3. A fourth peak P4 at time t4 corresponds to the optical signal detected when the cell C passes through the fourth position detection line L4.

Moreover, a signal PR also corresponds to the optical signal detected when the cell C passes through a plurality of detection positions randomly arranged in the detection area R.

Step S20: The time difference calculation unit 812 calculates the time difference τ between time t1 when the passage of the cell C has been detected as the peak intensity of the optical signal at any detection position on the first position detection line L1 and time t2 when the photodetector 6 has detected the passage of the cell as the peak intensity of the optical signal at any detection position on the second position detection line L2 on the basis of the electronic data SD acquired by the signal intensity acquisition unit 811. Here, the time difference calculation unit 812 reads the time corresponding to the first peak P1 as time t1 from the measured signal SG indicated in the electronic data SD, reads the time corresponding to the second peak P2 as time t2, and calculates the time difference τ from the read times t1 and t2.

Step S30: The flow rate calculation unit 813 calculates the flow rate v of the fluid flowing through the flow path 20. Here, the flow rate calculation unit 813 calculates the flow rate v on the basis of the time difference dt34 between time t3 when the photodetector 6 has detected the passage of the cell as the peak intensity of the optical signal LS at any detection position on the third position detection line L3 and time t4 when the photodetector 6 has detected the passage of the cell as the peak intensity of the optical signal at any detection position on the fourth position detection line L4, which is calculated on the basis of the electronic data SD acquired by the signal intensity acquisition unit 811, and the flow rate measurement distance D34. The flow rate calculation unit 813 reads the time corresponding to the third peak P3 as time t3 from the measured signal SG indicated in the electronic data SD, reads the time corresponding to the fourth peak P4 as time t4, and calculates the time difference dt34 between the read times t3 and t4. The flow rate calculation unit 813 calculates the flow rate v by dividing the flow rate measurement distance D34 indicated in the flow rate measurement distance information 819 by the calculated time difference dt34.

Step S40: The position detection distance calculation unit 814 calculates the position detection distance D12 corresponding to the position x of the cell C in the width direction of the flow path 20 on the basis of the time difference τ calculated by the time difference calculation unit 812 and the flow rate v calculated by the flow rate calculation unit 813. Here, the time difference calculation unit 812 calculates the position detection distance D12 corresponding to the position x by dividing the time difference τ by the flow rate v.

Step S50: The position calculation unit 815 calculates the position x of the cell C in the width direction of the flow path 20 on the basis of the position detection distance D12 calculated by the position detection distance calculation unit 814 and the detection distance/width direction correspondence information 818.

As described above, the position detection distance D12 is calculated on the basis of the time difference τ calculated by the time difference calculation unit 812 and the flow rate v. That is, the position detection distance D12 is an amount calculated on the basis of the time difference τ. Therefore, the position calculation unit 815 calculates the position x of the cell C in the width direction of the flow path 20 on the basis of the time difference τ calculated by the time difference calculation unit 812 and the detection distance/width direction correspondence information 818.

Step S60: The output unit 816 outputs the position x of the cell C in the width direction of the flow path 20 calculated by the position calculation unit 815 to the flow path position control device 9.

With this, the calculation unit 81 ends the position calculation process.

Although the example in which the flow rate v is measured using the position detection lines L (the third position detection line L3 and the fourth position detection line L4) for measuring the flow rate v of the fluid flowing through the flow path 20 has been described in the present embodiment, the present invention is not limited thereto. Instead of measuring the flow rate V, the calculation unit 81 may acquire the value of the flow rate V from the outside and perform a position calculation process.

When the calculation unit 81 acquires the value of the flow rate v from the outside and the position calculation process is performed, the position detection lines L for measuring the flow rate v may not be arranged on the flow path 20. In this case, the calculation unit 81 includes a flow rate acquisition unit instead of the flow rate calculation unit 813. This flow rate acquisition unit, for example, acquires the value of the flow rate v from the microfluidic device 2. In the position calculation process of FIG. 5, instead of step S30, a process in which the flow rate acquisition unit acquires the value of the flow rate v from the microfluidic device 2 is performed. Moreover, in step

S40, the position detection distance calculation unit 814 calculates the position detection distance D12 corresponding to the position x of the cell C in the width direction of the flow path 20 on the basis of the time difference τ calculated by the time difference calculation unit 812 and the flow rate v acquired by the flow rate acquisition unit.

### (Modified Example 1)

Although the example in which the position detection line L used to measure the position x of the cell C in the width direction of the flow path 20 and the position detection line L used to measure the flow rate v of the fluid flowing through the flow path 20 have been separately arranged has been described in the above-described embodiment, the present invention is not limited thereto. In Modified Example 1, an example in which one position detection line L also serves for any one of the position detection lines L used to measure the position x of the cell C in the width direction of the flow path 20 and any one of the position detection lines L used to measure the flow rate v of the fluid flowing through the flow path 20 will be described.

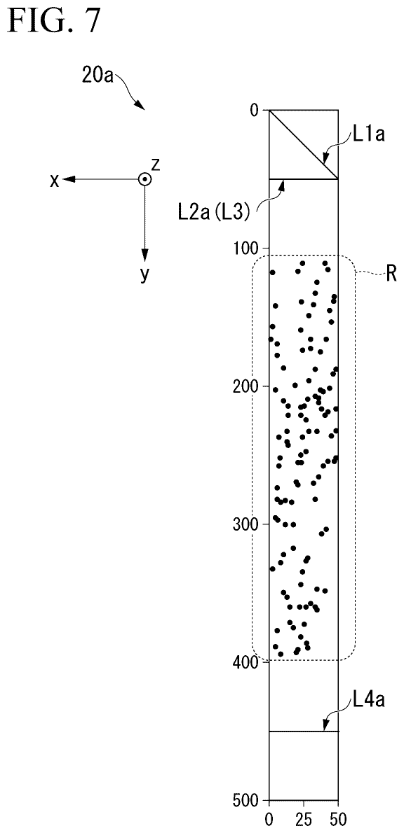

FIG. 7 is a diagram showing an example of position detection lines La according to Modified Example 1. In the flow path 20a, a first position detection line L1a, a second position detection line L2a, and a fourth position detection line L4a are arranged as the position detection lines La. The first position detection line L1a and the second position detection line L2a are position detection lines La for measuring the position x. Here, the second position detection line L2a is a position detection line La for measuring the position x and a position detection line La used to measure the flow rate v. That is, in the flow path 20a, the second position detection line L2a also serves for the third position detection line L3. The fourth position detection line L4a is a position detection line La used to measure the flow rate v.

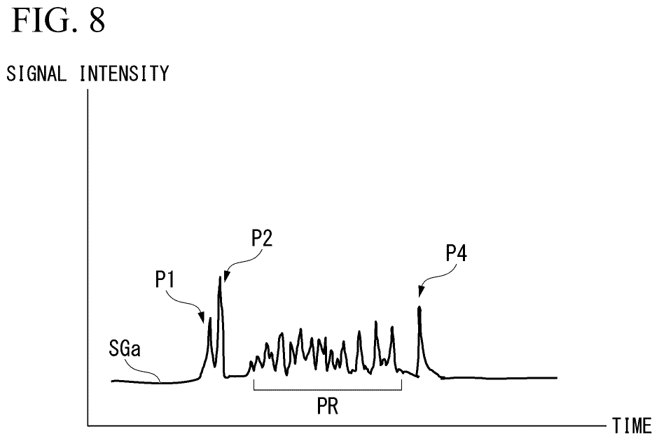

FIG. 8 is a diagram showing an example of a measured signal SGa according to Modified Example 1. The first peak P1 at time t1 corresponds to the optical signal detected when the cell C passes through the first position detection line L1a. The second peak P2 at time t2 corresponds to the optical signal detected when the cell C passes through the second position detection line L2a. The fourth peak P4 at time t4 corresponds to the optical signal detected when the cell C passes through the fourth position detection line L4a.

In calculating the flow rate v of step S30 described above, the flow rate calculation unit 813 reads the time corresponding to the second peak P2 as time t2 from the measured signal SGa, reads the time corresponding to the fourth peak P4 as time t4, and calculates the time difference dt34 between the read times t2 and t4. In Modified Example 1, because the second position detection line L2a also serves for the third position detection line L3, time t2 corresponding to the second peak also serves for time t3 corresponding to the third peak P3.

### (Modified Example 2)

Although the example in which two position detection lines L (the first position detection line L1 and the second position detection line L2) are arranged on the flow path 20 to measure the position x of the cell C in the width direction of the flow path 20 and the position x is measured once when one cell C passes through the flow path 20 has been described in the above-described embodiment, the present invention is not limited thereto. The position x of the cell C in the width direction of the flow path 20 may be measured multiple times when one cell C passes through the flow path 20. In Modified Example 2, an example in which three or more position detection lines L for measuring the position x are arranged will be described.

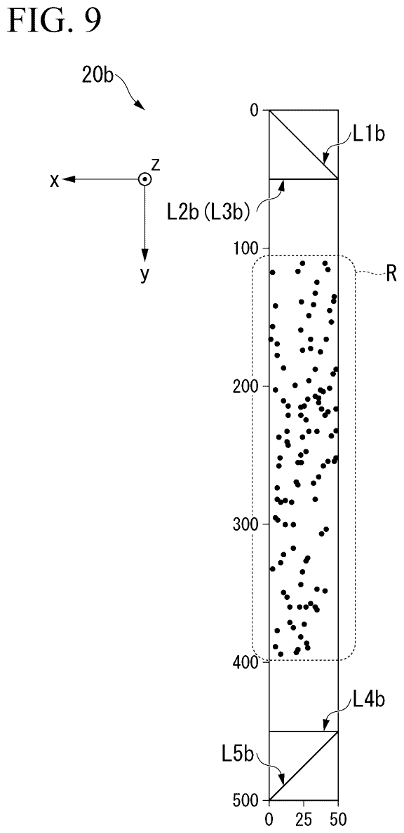

FIG. 9 is a diagram showing an example of the position detection line Lb according to Modified Example 2. In the flow path 20b, a first position detection line L1b, a second position detection line L2b, a fourth position detection line L4b, and a fifth position detection line L5b are arranged as position detection lines Lb. In the flow path 20b, the first position detection line L1b, the second position detection line L2b, the fourth position detection line L4b, and the fifth position detection line L5b are position detection lines Lb for measuring the position x. That is, the four position detection lines L for measuring the position x are arranged on the flow path 20b.

In Modified Example 2, first measurement of the position x is performed using the first position detection line L1b and the second position detection line L2b and second measurement of the position x is performed using the fourth position detection line L4b and the fifth position detection line L5b after the cell C passes through the detection area R. A position x1, which is the position x measured for the first time, and a position x2, which is the position x measured for the second time, are used, for example, to measure the inclination of the flow line.

The second position detection line L2b and the fourth position detection line L4b are a position detection line Lb for measuring the position x and a position detection line Lb used for measuring the flow rate v. That is, in the flow path 20b, as in Modified Example 1 described above, the second position detection line L2a for measuring the position x also serves for the third position detection line L3 used for measuring the flow rate v. Moreover, the position detection line used for the second measurement of the position x also serves for the fourth position detection line L4b used for measuring the flow rate v.

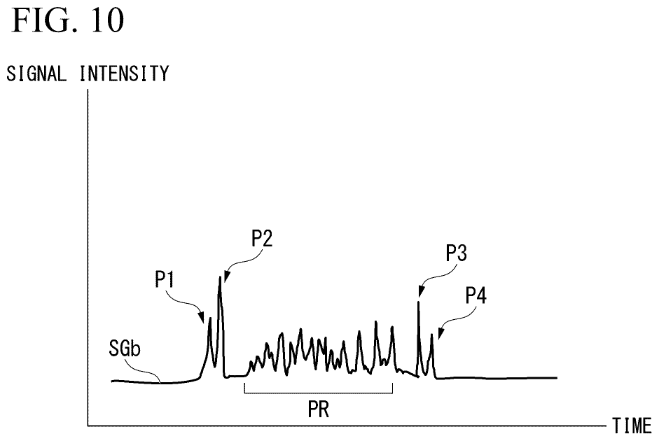

FIG. 10 is a diagram showing an example of a measured signal SGb according to Modified Example 2. The first peak P1 at time t1 corresponds to an optical signal detected when the cell C passes through the first position detection line L1b. The second peak P2 at time t2 corresponds to an optical signal detected when the cell C passes through the second position detection line L2b. The third peak P3 at time t3 corresponds to an optical signal detected when the cell C passes through the fourth position detection line L4b. The fourth peak P4 at time t4 corresponds to an optical signal detected when the cell C passes through the fifth position detection line L5b.

In calculating the flow rate v of step S20 described above, the time difference calculation unit 812 reads the time corresponding to the first peak P1 as time t1 from the measured signal SGb, reads the time corresponding to the second peak P2 as time t2, and calculates a difference between the read times t1 and t2 as a time difference τ1. Moreover, the time difference calculation unit 812 reads the time corresponding to the third peak P3 as time t1, reads the time corresponding to the fourth peak P4 as time t2, and calculates a difference between the read times t1 and t2 as a time difference τ2.

In step S40, the position detection distance calculation unit 814 calculates a position detection distance D12-1 corresponding to a position x1 of the cell C in the width direction of the flow path 20 on the basis of a time difference τ1 calculated by the time difference calculation unit 812 and a flow rate v calculated by the flow rate calculation unit 813. Furthermore, the position detection distance calculation unit 814 calculates a position detection distance D12-2 corresponding to a position x2 of the cell C in the width direction of the flow path 20 on the basis of a time difference τ2 calculated by the time difference calculation unit 812 and a flow rate v calculated by the flow rate calculation unit 813.

In step S50, the position calculation unit 815 calculates the positions x1 and x2 of the cell C in the width direction of the flow path 20 on the basis of the position detection distance D12-1 and the position detection distance D12-2 calculated by the position detection distance calculation unit 814 and the detection distance/width direction correspondence information 818. The position calculation unit 815 calculates an inclination of the flow line of the fluid flowing through the flow path 20 on the basis of the calculated positions x1 and x2. The position calculation unit 815 may correct the position x on the basis of the calculated inclination of the flow line.

Also, the position detection distance calculation unit 814, for example, may calculate an average of the position detection distance D12-1 calculated on the basis of the time difference τ1 and the position detection distance D12-2 calculated on the basis of the time difference τ2 as the position detection distance D12. Moreover, in step S20, the time difference calculation unit 812 may calculate an average of the time difference τ1 and the time difference τ2 as the time difference τ.

### (Modified Example 3)

Although the example in which the angle between the two position detection lines L for measuring the position x of the cell C in the width direction of the flow path 20 is 45 degrees on the flow path 20 has been described in the above-described embodiment and its modified examples, the present invention is not limited thereto. In Modified Example 3, an example in which the angle between a first position detection line L1c and a second position detection line L2c is 45 degrees or more will be described.

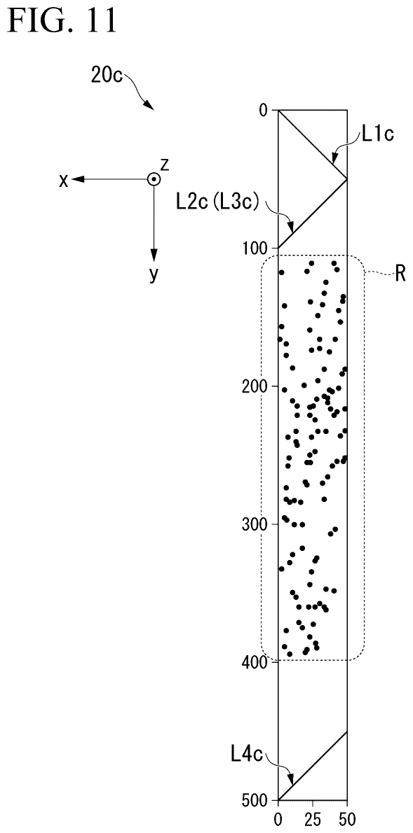

FIG. 11 is a diagram showing an example of position detection lines Lc according to Modified Example 3. On a flow path 20c, a first position detection line L1c, a second position detection line L2c, a third position detection line L3c, and a fourth position detection line L4c are arranged as the position detection lines Lc. On the flow path 20c, the first position detection line L1c and the second position detection line L2c are the position detection lines Lc for measuring the position x. Here, the second position detection line L2c is a position detection line Lc for measuring the position x and a position detection line Lc used for measuring the flow rate v. That is, on the flow path 20c, the second position detection line L2c also serves for the third position detection line L3c. The fourth position detection line L4c is the position detection line Lc used for measuring the flow rate v.

Here, the angle between the first position detection line L1c and the second position detection line L2c is installed at a predetermined angle (for example, 45 degrees) or more. In the example of FIG. 11, the angle between the first position detection line L1c and the second position detection line L2c is 90 degrees.

The fourth position detection line L4c is arranged substantially parallel to the second position detection line L2c. Unlike the flow path 20 in FIG. 3, in the flow path 20c of FIG. 11, because the second position detection line L2c is inclined with respect to the width direction of the flow path 20c, the position detection line Lc used to measure the flow rate v is inclined with respect to the width direction of the flow path 20c.

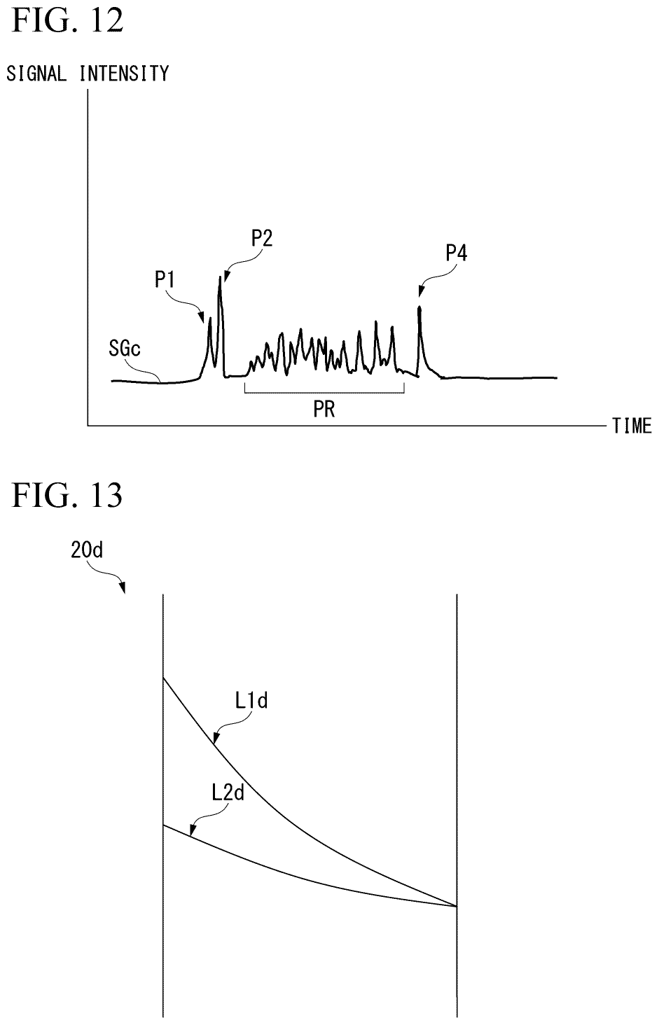

FIG. 12 is a diagram showing an example of a measured signal SGc according to Modified Example 3. The first peak P1 at time t1 corresponds to an optical signal detected when the cell C passes through the first position detection line L1c. The second peak P2 at time t2 corresponds to an optical signal detected when the cell C passes through the second position detection line L2c. The fourth peak P4 at time t4 corresponds to an optical signal detected when the cell C passes through the fourth position detection line L4c.

Here, the longer the position detection distance D12, the longer the time difference τc between the first peak P1 and the second peak P2 in the measured signal SGc. The longer the time difference between the first peak P1 and the second peak P2, the higher the accuracy with which the time difference calculation unit 812 reads the times corresponding to the first peak P1 and the second peak P2. That is, the longer the time difference between the first peak P1 and the second peak P2, the higher the temporal resolution for the first peak P1 and the second peak P2. The higher the temporal resolution for the first peak P1 and the second peak P2, the higher the accuracy of the measurement of the position x of the cell C in the width direction of the flow path 20.

Therefore, by increasing the angle between the first position detection line L1c and the second position detection line L2c and increasing the position detection distance D12, the accuracy of the measurement of the position x of the cell C in the width direction of the flow path 20 in the calculation unit 81 is increased.

As described above, in order to improve the measurement accuracy of position x, the angle between the two position detection lines L is preferably a predetermined angle (for example, 45 degrees) or more, but this angle may be a predetermined angle (for example, 45 degrees) or less.

### (Modified Example 4)

Although an example in which the position detection line Lis a straight line has been described in the above-described embodiment, the present invention is not limited thereto. In Modified Example 4, an example in which the position detection line Lis a line other than a straight line will be described.

FIG. 13 is a diagram showing an example of position detection lines Ld according to Modified Example 4. A first position detection line L1d and a second position detection line L2d are position detection lines Ld for measuring a position x of the cell C in a width direction of a flow path 20d. The first position detection line L1d and the second position detection line L2d are curved lines. Here, a position detection distance D12d, which is a distance between the first position detection line L1d and the second position detection line L2d, monotonically changes with the position in the width direction of the flow path 20d. Because the position detection distance D12d monotonically changes with the position in the width direction of the flow path 20d, the position detection distance D12d corresponds to the position in the width direction of the flow path 20d on a one-to-one basis.

Also, the position detection line L is not limited to a curved line. The position detection line L may be a continuous line in the width direction of the flow path 20 if the position detection distance D12 monotonically changes with the position in the width direction of the flow path 20. For example, the position detection line L may be a polygonal line.

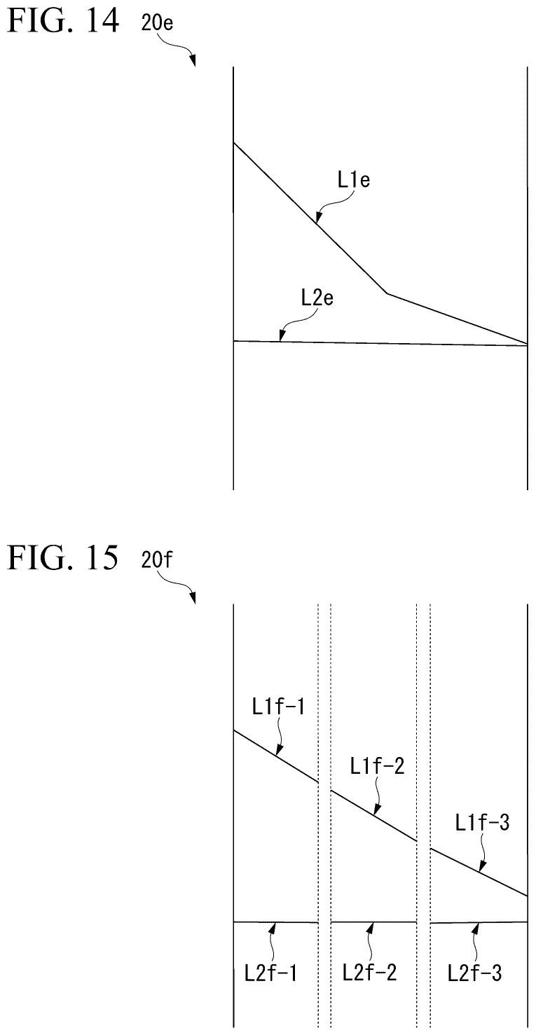

FIG. 14 is a diagram showing an example of other position detection lines Le according to Modified Example 4. A first position detection line L1e is a polygonal line. A second position detection line L2e is a straight line. A position detection distance D12e, which is a distance between a first position detection line L1e and a second position detection line L2e, monotonically changes with the position in the width direction of a flow path 20e. As long as a position detection distance D12e monotonically changes with the position in the width direction of the flow path 20e, the second position detection line L2e may be a polygonal line. Moreover, as long as the position detection distance D12e monotonically changes with the position in the width direction of the flow path 20e, the first position detection line L1e may be a straight line and the second position detection line L2e may be a polygonal line.

Moreover, the position detection line L may include a plurality of discrete line segments as long as the position detection distance D12d corresponds to the position in the width direction of the flow path 20 on a one-to-one basis.

FIG. 15 is a diagram showing yet another example of position detection lines Lf according to Modified Example 4. Each of a first position detection line L1f and a second position detection line L2f includes a plurality of discrete line segments. The first position detection line L1f includes a line segment L1f-1, a line segment L1f-2, and a line segment L1f-3. The second position detection line L2f includes a line segment L2f-1, a line segment L2f-2, and a line segment L2f-3. The position detection distance D12e, which is the distance between the first position detection line L1f and the second position detection line L2f, monotonically changes with the position in the width direction of the flow path 20f.

Also, when the position detection line Lf includes a plurality of discrete line segments, a gap between two or more line segments is set to a pixel spacing sufficiently small as compared to the size of the cell C. As a specific numerical value, for example, for a cell of about 5 to 30 micrometers, a gap of about 1 micrometer may be provided between the two or more line segments. Alternatively, a gap of 2 to 3 micrometers, which is about one-tenth of the cell size, may be provided for large cells of 20 to 30 micrometers and the like.

### (Modified Example 5)

Although the example in which the two position detection lines L (the first position detection line L1 and the second position detection line L2) for measuring the position x of the cell C in the width direction of the flow path 20 are in contact at one end has been described in the above-described embodiment, the present invention is not limited thereto.

FIG. 16 is a diagram showing an example of position detection lines Lg according to Modified Example 5. On a flow path 20g, a first position detection line L1g and a second position detection line L2g are not in contact at one end. That is, a minimum value of the position detection distance D12g, which is the distance between the first position detection line L1g and the second position detection line L2g, is a predetermined value that is not zero. Here, the position detection distance D12g and the position in the width direction of the flow path 20g change monotonically.

Also, one of the first position detection line L1g and the second position detection line L2g may be arranged further upstream along the flow path 20 (in the −y-direction of the y-axis direction) than the detection area R and the other may be arranged further downstream (in the +y-direction of the y-axis direction) than the detection area R.

### (Modified Example 6)

Although the example in which the length of the position detection line L in the width direction of the flow path 20 is equal to the width of the flow path 20 has been described in the above-described embodiment, the present invention is not limited thereto. The length of the position detection line L may be shorter than the width of the flow path 20. For example, a range in which the position detection line Lis not arranged at both ends of the flow path 20 in the width direction may be provided.

FIG. 17 is a diagram showing an example of position detection lines Lh according to Modified Example 6. A length of a first position detection line L1h in a width direction of a flow path 20h and a length of a second position detection line L2h in the width direction of the flow path 20h are shorter than a width of the flow path 20h. That is, in the flow path 20h, position detection lines Lh are not arranged at both ends in the width direction. Also, a length of a range in which the position detection line L is not arranged at both ends of the flow path 20 in the width direction is preferably narrower than the size of the cell C.

Moreover, when a range in which the position detection line L is not arranged at both ends of the flow path 20 in the width direction is provided, it is preferable to perform a control process so that the cell C flows near the center of the flow path 20 in the width direction (the x-axis direction) thereof. For example, it is possible to perform a control process so that the cell C flows near the center of the flow path 20 by generating a flow of the fluid from the side to the center of the flow path 20 in the width direction (the x-axis direction) thereof.

As described above, the flow cytometer 1 according to the present embodiment includes the microfluidic device 2, the light source 3, the photodetector 6, an information generation device (the information generation unit 80 in the present embodiment), and a calculation device (the calculation unit 81 in the present embodiment).

The microfluidic device 2 includes the flow path 20 through which the observation object (the cell C in the present embodiment) can flow with the fluid.

The light source 3 irradiates illumination light LE to the flow path 20.

The photodetector 6 detects the intensity of an optical signal (an optical signal when the optical signal LS is collected by the photodetection optical system 5 in the present embodiment) emitted from the observation object (the cell C in the present embodiment) in a time series when the illumination light LE is irradiated to the observation object (the cell C in the present embodiment) flowing through the flow path 20.

The information generation device (the information generation unit 80 in the present embodiment) generates optical information indicating any one or more of a shape, form, and structure of the observation object (the cell C in the present embodiment) on the basis of the electronic data into which the electrical signal pulse output by the photodetector 6 is converted.

The calculation device (the calculation unit 81 in the present embodiment) calculates the position x of the observation object (the cell C in the present embodiment) in the width direction of the flow path 20 on the basis of the time when the peak is detected in the temporal changes in the signal intensity of the optical signal LS detected by the photodetector 6.

Here, in the microfluidic device 2, the first position detection line L1, which is a group of a plurality of detection positions where the photodetector 6 detects a position of the observation object (the cell C in the present embodiment) and a position detection line L having at least a length in the width direction, is arranged on the flow path 20, the second position detection line L2, which is the position detection line L, is arranged with a portion overlapping the first position detection line L1 in the width direction of the flow path 20, and the position detection distance D12, which is a distance between the first position detection line L1 and the second position detection line L2 in a length direction of the flow path 20, changes with a position in the width direction of the flow path 20.

The calculation device (the calculation unit 81 in the present embodiment) includes the time difference calculation unit 812 and the position calculation unit 815.

The time difference calculation unit 812 calculates the time difference τ between the time when the photodetector 6 has detected the passage of the cell as the peak intensity of the optical signal at any one detection position on the first position detection line L1 and the time when the photodetector 6 has detected the passage of the cell as the peak intensity of the optical signal at any one detection position on the second position detection line L2.

The position calculation unit 815 calculates the position x of the observation object (the cell C in the present embodiment) in the width direction of the flow path 20 on the basis of the time difference τ calculated by the time difference calculation unit 812 and a corresponding relationship between the time difference τ and the position in the width direction of the flow path 20.

According to this configuration, the flow cytometer 1 according to the present embodiment can calculate the position x of the observation object in the width direction of the flow path 20, so that the position deviation of the flow line can be detected.

In the flow cytometer 1 according to the present embodiment, the position detection lines L (the first position detection line L1 and the second position detection line L2 in one example of the present embodiment) for calculating the position x of the observation object in the width direction of the flow path 20 can be easily arranged on the flow path 20 by including and arranging them in an illumination pattern for acquiring optical information related to the morphological information of the cell. Therefore, the position of the flow path can be appropriately corrected to continue measurement under suitable conditions even if the position deviation of the flow line occurs.

The flow cytometer 1 according to the present embodiment can calculate the position x of the observation object in the width direction of the flow path 20 while measuring the observation object. Although the method of responding to the detected position deviation of the flow line by controlling the position of the flow path has been described in the above-described example, methods for measuring the observation object by correcting the position deviation of the flow line is not limited thereto. For example, it is also possible to correct flow line deviation by moving the irradiation position in accordance with detected position deviation of the flow line.

Moreover, the flow cytometer 1 according to the present embodiment further includes a flow path position control device 9. The flow path position control device 9 controls the position of the flow path 20 on the basis of a calculation result of the calculation device (the calculation unit 81 in the present embodiment).

According to this configuration, the flow cytometer 1 according to the present embodiment can control the position of the flow path 20 on the basis of the calculation result obtained by calculating the position x of the observation object in the width direction of the flow path 20, so that the position of the flow path can be corrected with respect to the position deviation of the flow line.

Moreover, in the flow cytometer 1 according to the present embodiment, the third position detection line L3 serving as the position detection line Lis arranged on the flow path 20 and the fourth position detection line L4, which is serving as a position detection line L and is approximately parallel to the third position detection line L3, is arranged at a distance of flow rate measurement distance D34, which is a predetermined distance from the third position detection line L3. The fourth position detection line L4 has a portion overlapping the third position detection line L3 in the width direction of the flow path 20.

The calculation device (the calculation unit 81 in the present embodiment) further includes the flow rate calculation unit 813 and the position detection distance calculation unit 814.

The flow rate calculation unit 813 calculates the flow rate v of the fluid flowing through the flow path 20 on the basis of the time when the photodetector 6 has detected the peak intensity of the optical signal at any one detection position on the third position detection line L3, the time when the photodetector 6 has detected the peak intensity of the optical signal at any one detection position on the fourth position detection line L4, and the flow rate measurement distance D34.

The position detection distance calculation unit 814 calculates the position detection distance D12 corresponding to the position x of the observation object (the cell C in the present embodiment) in the width direction of the flow path 20 on the basis of the time difference τ calculated by the time difference calculation unit 812 and the flow rate v calculated by the flow rate calculation unit 813.

According to this configuration, the flow cytometer 1 according to the present embodiment can sequentially measure the flow rate v of the fluid flowing through the flow path 20 and calculate the position x of the observation object in the width direction of the flow path 20 using the value of the measured flow rate v, so that it is possible to continue measurement under suitable conditions while correcting the position of the flow path with respect to the position deviation of the flow line even if the flow rate v of the fluid flowing through the flow path 20 fluctuates or deviates from the set value.

Here, the flow rate v of the fluid flowing through the flow path 20 is set by, for example, the microfluidic device 2, but the actual flow rate v may be different from the set flow rate v. In the flow cytometer 1 according to the present embodiment, because it is possible to simultaneously measure the flow rate v while allowing the observation object to flow through the flow path 20, it is possible to use more accurate value of the flow rate v to calculate the position detection distance D12 as compared with a case where a value of the set flow rate v is used.

Moreover, in the flow cytometer 1 according to Modified Example 1 of the present embodiment, the second position detection line L2 also serves for the third position detection line L3.

According to this configuration, in the flow cytometer 1 according to the present embodiment, in the measured signal SG, the third peak P3 corresponding to the optical signal detected when the cell C passes through the third position detection line L3 is used in common with the second peak P2 corresponding to the optical signal detected when the cell C passes through the second position detection line L2 and is used for both a process in which the time difference calculation unit 812 calculates the time difference τ and a process in which the flow rate calculation unit 813 calculates the flow rate v. Because it is possible to reduce the number of position detection lines arranged according to this configuration, the device can be more easily configured.

Moreover, in the flow cytometer 1 according to the present embodiment, the information generation device (the information generation unit 80 in the present embodiment) generates optical information on the basis of the intensity of the optical signal LS emitted from the observation object (the cell C in the present embodiment) by the irradiation of illumination light obtained by applying a structuring process (the structured illumination light SLE in the present embodiment) to the observation object (the cell C in the present embodiment) flowing through the flow path 20. The structuring process is performed by a configuration of structured illumination.

In the configuration of the structured illumination as described above, the spatial light modulation unit 4 is installed in the flow cytometer 1 on the optical path between the light source 3 and the flow path 20 to structure the illumination light LE. In the configuration of the structured illumination, the light source 3 irradiates the flow path 20 with the illumination light structured by the spatial light modulation unit 4 (the structured illumination light SLE in the present embodiment).

According to this configuration, the flow cytometer 1 according to the present embodiment can calculate the position x in the width direction of the flow path 20 in parallel with the generation of optical information of the observation object with the structured illumination, so that it is possible to perform measurement of the observation object using the structured illumination, which is sensitive to the position deviation, while detecting the position deviation of the flow line.

Moreover, in the flow cytometer 1 according to the present embodiment, the position detection line Lis a continuous line in the width direction of the flow path 20 and the position detection distance D12 monotonically changes with the position in the width direction of the flow path 20.

According to this configuration, in the flow cytometer 1 according to the present embodiment, because the position detection distance D12 corresponds to the position in the width direction of the flow path 20 on a one-to-one basis, the position detection distance D12 can be converted into the position x of the cell C in the width direction of the flow path 20.

Moreover, in the flow cytometer 1 according to the present embodiment, the position detection line L has a length in the width direction of the flow path 20 equal to the width of the flow path 20.

According to this configuration, in the flow cytometer 1 according to the present embodiment, because there is no gap in the position detection line L in the width direction of the flow path 20, it is possible to prevent a case where the cell C does not pass through the position detection line L regardless of the size of the cell C and the measurement of the position x of the cell C in the width direction of the flow path 20 fails.

Moreover, in the flow cytometer 1 according to the present embodiment, the position detection line L is a straight line.

According to this configuration, in the flow cytometer 1 according to the present embodiment, the arrangement of the position detection line L in the flow path 20 is easy as compared with a case where the position detection line L is not a straight line. Here, as described above, the position detection line Lis a group of a plurality of detection positions and the plurality of detection positions are implemented as a pattern of the structured illumination which is modulated by the spatial light modulation unit 4 and is irradiated to the flow path. The structured illumination pattern is configured, for example, as a group of a plurality of irradiation areas in which a light transmission area having a shape of a square or the like is a unit. Therefore, the shape of the position detection line L is easily implemented with a straight line, compared with a curved line, in when a light transmission area having a shape of a square or the like is a unit in a case where a light transmission area having a shape of a square or the like is a unit. Moreover, when a position relationship between the position detection distance D12 and the width direction of the flow path 20 is one-to-one correspondence, the corresponding relationship is simple and the arrangement of the detection position or the like is easy.

Moreover, in the flow cytometer 1 according to Modified Example 3 of the present embodiment, an angle between the first position detection line L1 and the second position detection line L2 is greater than or equal to a predetermined value.

According to this configuration, in the flow cytometer 1 according to the present embodiment, the position detection distance D12, which is the distance between the first position detection line L1 and the second position detection line L2, can be longer than when the angle between the first position detection line L1 and the second position detection line L2 is less than a predetermined value and the accuracy of measurement of the time when the cell C has passed through the first position detection line L1 and the time when the cell C has passed through the second position detection line L2 can be improved. As such, it is possible to improve the accuracy of measurement of the position x of the cell C in the width direction of the flow path 20.

Moreover, the flow cytometer 1 according to the present embodiment includes the spatial light modulation unit 4 configured to structure the illumination light LE on the optical path between the light source 3 and the flow path 20, wherein the position detection lines (the first position detection line L1 and the second position detection line L2 in the present embodiment) are arranged according to the structured illumination light SLE.

According to this configuration, in the flow cytometer 1 according to the present embodiment, because the arrangement of the position detection line can be implemented according to structured illumination for acquiring optical information, the position detection line can be easily set on the flow path 20.

### Second Embodiment

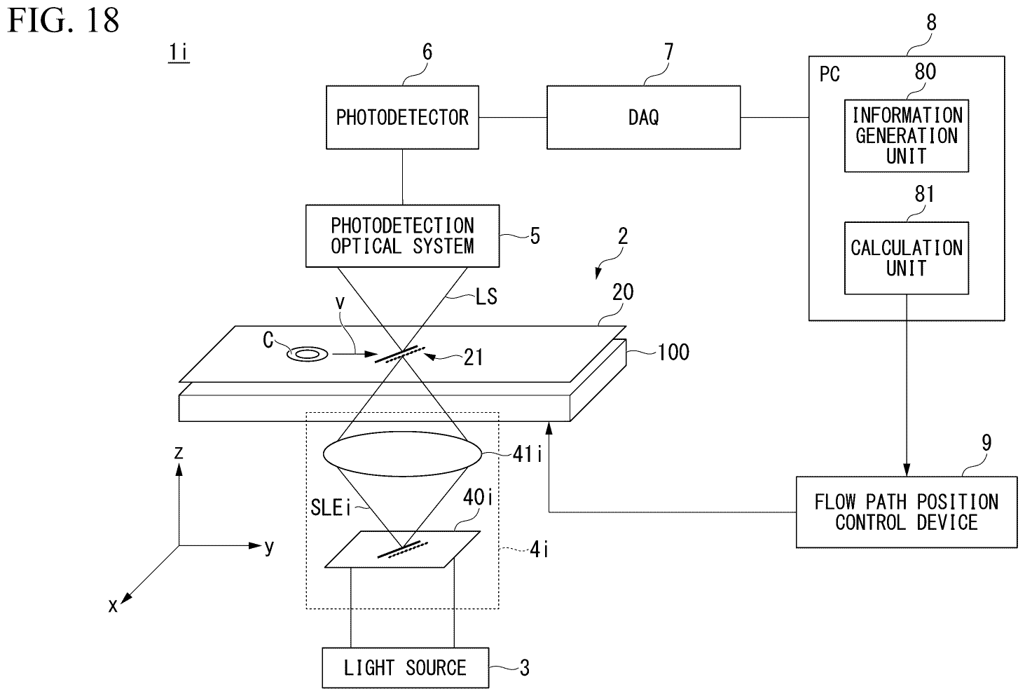

Although an example in which the illumination light LE is structured by the spatial light modulator 40 has been described above, the present invention is not limited thereto. A spatial light modulation unit may include a mask instead of the spatial light modulator and an observation object may be irradiated with illumination light structured by the mask. Structuring the illumination light means modulating optical characteristics of the illumination light for each of a plurality of areas included in an incident surface of the mask for the illumination light. A flow cytometer 1i according to the second embodiment will be described with reference to FIG. 18. FIG. 18 is a diagram showing an example of the flow cytometer 1i according to the second embodiment. The present embodiment is an example of a configuration of the structured illumination.

A configuration of the flow cytometer 1i (FIG. 18) is similar to that of the flow cytometer 1 (FIG. 1), except that a spatial light modulation unit 4i is provided instead of the spatial light modulation unit 4.

The spatial light modulation unit 4i includes a mask 40i and a first lens 41i. The mask 40i and the first lens 41i are arranged on an optical path between a light source 3 and a photodetector 6 in that order from the side close to the light source 3.

The mask 40i is a spatial filter having areas where light is transmitted (a light transmission area) and areas where no light is transmitted. The arrangement of the light transmission areas provided in the mask 40i corresponds to a pattern of a structural illumination pattern 21. The mask 40i generates structured illumination light SLEi by transmitting and structuring the illumination light LE from the light source 3 in its light transmission areas. In the present modified example, the structural illumination pattern 21 is generated by an arrangement pattern of the light transmission areas of the mask 40i. The mask 40i is, for example, a film in which a plurality of areas with different optical characteristics are printed on a surface, a filter having areas where light is transmitted and areas where no light is transmitted, or the like.

The first lens 41i collects the structured illumination light SLEi generated by the mask 40i and forms an image on the flow path 20. Here, the light transmission areas on the mask 40i and the structural illumination pattern 21 on the flow path 20 are in conjugate positions with respect to the first lens 41i.

Also, as a configuration different from the above-described configuration, it is also possible to have a configuration in which an image of the structured illumination light SLEi is not formed by the first lens 41i. When the image of the structured illumination light SLEi is not formed by the first lens 41i, the mask 40i is provided directly under the flow path 20 on the optical path between the light source 3 and the photodetector 6. Here, a position directly under the flow path 20 is nearest the light source 3 side of the flow path 20. Also, when the image of the structured illumination light SLEi is not formed by the lens, the first lens 41i is omitted from the configuration of the spatial light modulation unit 4.

Moreover, the spatial light modulation unit 4i may include a mirror 42i (not shown) that functions as a spatial filter instead of the mask 40i. The mirror 42i is a spatial filter having areas where light is transmitted (a light transmission area) and areas where light is reflected. In this case, the areas of the mirror 42i where the light is reflected corresponds to the optical signal detection position. When the spatial light modulation unit 4i includes the mirror 42i, the light source 3 is provided on the flow path 20 side with respect to the mirror 42i.

### Third Embodiment

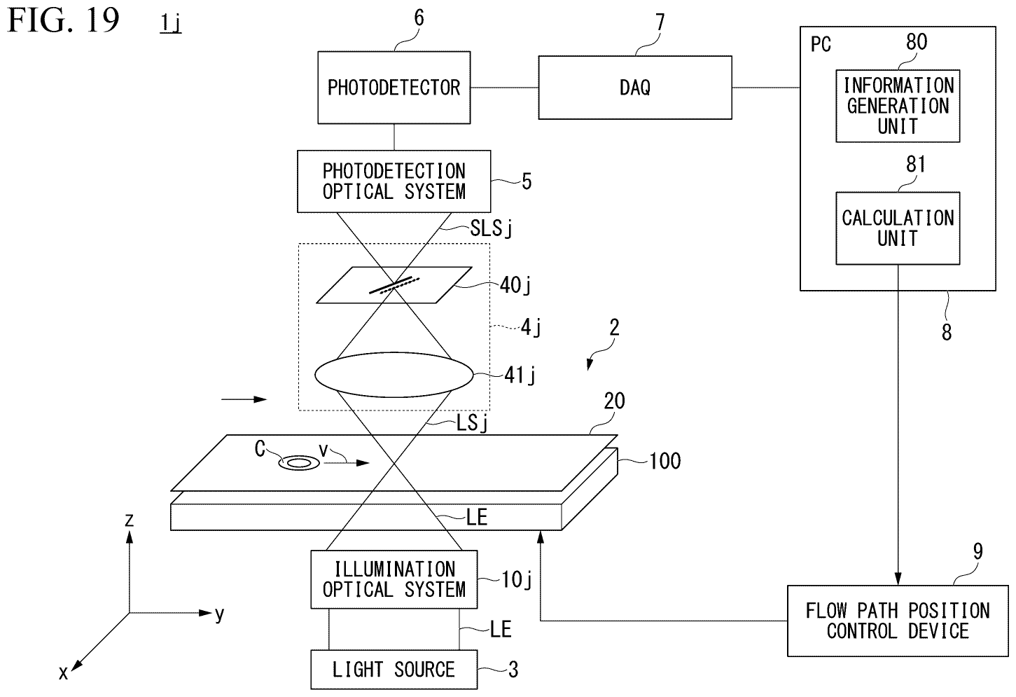

Although a configuration of structured illumination in which the spatial light modulation unit 4 and the spatial light modulation unit 4i modulate the illumination light LE has been described above, the present invention is not limited thereto. A flow cytometer 1j, which is a flow cytometer of the third embodiment, will be described with reference to FIG. 19. FIG. 19 is a diagram showing an example of the flow cytometer 1j according to the third embodiment.

The configuration of the flow cytometer 1j (FIG. 19) is similar to that of the flow cytometer 1 (FIG. 1), except that a spatial light modulation unit 4j and an illumination optical system 10j are provided instead of the spatial light modulation unit 4. The spatial light modulation unit 4j includes a first lens 41j and a mask 40j. The first lens 41j and the mask 40j are arranged on the optical path between the light source 3 and the photodetector 6 in that order from the side close to a light source 3.

The spatial light modulation unit 4j including the mask 40j is provided at a position in front of a photodetection optical system 5 and a photodetector 6 on the optical path between the light source 3 and a photodetector 6. That is, the optical signal LSj emitted from a cell C is irradiated to the mask 40j via the first lens 41j and structured. Structuring the optical signal means modulating the optical characteristics of signal light for each of a plurality of areas included in an incident surface of a mask for the optical signal. As in the present embodiment, a configuration in which the spatial light modulation unit 4j is provided at a position on the photodetector 6 side with respect to the flow path 20 on the optical path between the light source 3 and the photodetector 6 is also referred to as a structured detection configuration.

In the structured detection, a structured optical signal SLSj structured by the mask 40j is detected by the photodetector 6 via a light detecting optical system.

The mask 40j is a spatial filter having areas where light is transmitted (a light transmission area) and areas where no light is transmitted. The light transmission areas on the mask 40j and the position where the cell C is illuminated by the illumination optical system 10j on the flow path 20 are arranged at conjugate positions with respect to the first lens 41j.

The illumination optical system 10j illuminates the cell C flowing through the flow path 20 with illumination light LE from the light source 3. The first lens 41j collects the optical signal LSj from the cell C and forms its image on the mask 40j. The photodetector 6 detects a structured optical signal SLSj via the light transmission area of the mask 40j.

According to the above configuration, in structured detection, positions conjugated with the light transmission areas of the mask 40j can be arranged as optical signal detection positions from which the optical signal LS from the cell C passing through the flow path 20 is detected. As such, optical information about morphological information of the cell C or the position x of the cell C in the width direction is measured on the basis of the optical signal detected by the photodetector 6 via the optical signal detection position. That is, in the structured detection, a group of detection positions in the width direction of the flow path 20 can be arranged as a position detection line L according to the shape and arrangement pattern of the light transmission areas provided in the mask 40j. Also, arranging the position detection line according to the configuration of the structured detection as described above is referred to as arranging the position detection line according to the optical signal which is structured by the spatial light modulation unit.

Moreover, the spatial light modulation unit 4j may include a mirror 42j (not shown) that functions as a spatial filter instead of the mask 40j. The mirror 42j is a spatial filter having areas where light is transmitted (a light transmission area) and areas where light is reflected. Here, the light transmission areas of the mirror 42j corresponds to the optical signal detection positions.

Types of light transmitted in the light transmission areas are different between the spatial light modulation unit 4j (FIG. 19) and the spatial light modulation unit 4 (FIG. 1), other than whether it is provided on the photodetector 6 side or the light source 3 side with respect to the flow path 20. While the spatial light modulation unit 4 (FIG. 1) transmits the illumination light LE to form structured illumination light SLE, the spatial light modulation unit 4j (FIG. 19) transmits an optical signal LSj such as fluorescence, transmitted light, scattered light, or interference light from the cell C to form the structured optical signal SLSj. The functions of the spatial light modulation unit 4j (FIG. 19) and the spatial light modulation unit 4 (FIG. 1) are similar, except that the type of light transmitted in the light transmission areas is different.

Although the case where the irradiation positions including the position detection line L are all set by the same one spatial light modulation unit has been described as an example in the first embodiment and a modified example thereof, the present invention is not limited thereto. For example, the first position detection line L1 and the second position detection line L2 may be set by a structured illumination configuration like the spatial light modulation unit 4 (FIG. 1) and the third position detection line L3 and the fourth position detection line L4 may be set by a structured detection configuration like the spatial light modulation unit 4j. Moreover, in contrast, the third position detection line L3 and the fourth position detection line L4 may be set by a structured illumination configuration like the spatial light modulation unit 4 (FIG. 1) and the first position detection line L1 and the second position detection line L2 may be set by a structured detection configuration like the spatial light modulation unit 4j.

Moreover, the first position detection line L1 and the second position detection line L2 may be set by the configuration of structured illumination or structured detection by the spatial light modulation unit 4 (FIG. 1) or the spatial light modulation unit 4j (FIG. 19) and the third position detection line L3 and the fourth position detection line L4 may be set by an optical system consisting only of a normal lens or the like, in which no structuring of light is made by a spatial light modulation unit. In this case, a wavelength of light used to set the first position detection line L1 and the second position detection line L2 and a wavelength of light used to set the third position detection line L3 and the fourth position detection line L4 may be the same as or different from each other.

Furthermore, it is desirable to generate optical information about morphological information of the cell C generated by the information generation device on the basis of an optical signal emitted from the cell C irradiated with the structured illumination light SLE, which is made by applying a structuring process to the illumination light LE, or an optical signal that has been undergone a structuring process. In doing so, the structuring process may be performed by a configuration of structured illumination or a configuration of structured detection. Furthermore, when structuring processes are performed on the optical signal for which the information generation device generates the optical information and the optical signal for which the calculation device calculates the position in the width direction, it is desirable to perform the structuring processes in the same method, but the structuring processes may be performed in separate methods. Also, performing the structuring process here means modulating optical characteristics of the illumination light from the light source or the optical signal to be detected by the photodetector via the spatial light modulation unit according to the configuration of structured illumination or the configuration of structured detection. In other words, performing the structuring process means structuring the illumination light or optical signal.

In the flow cytometer 1j according to the present embodiment, the information generation device (the information generation unit 80 in the present embodiment) generates optical information on the basis of the intensity of the optical signal that has undergone a structuring process (the structured optical signal SLSj in the present embodiment). The structuring process is performed by a configuration of structured detection.

In the configuration of structured detection as described above, the flow cytometer 1j includes a spatial light modulation unit 4j, which is installed on the optical path between the flow path 20 and the photodetector 6, to structure the optical signal LSj. In the configuration of structured detection, the photodetector 6 detects the intensity of an optical signal obtained by structuring the optical signal LSj with the spatial light modulation unit 4j (the structured optical signal SLSj in the present embodiment), in a time series.

According to this configuration, in the flow cytometer 1j according to the present embodiment, it is possible to structure the optical signal LS emitted from the observation object (the cell C in the present embodiment) according to the configuration of structured detection and generate optical information on the basis of the intensity of the structured optical signal. In the flow cytometer 1j, because the position x of the observation object in the width direction of the flow path 20 can be calculated in parallel with the generation of optical information of the observation object according to the configuration of structured detection, it is possible to measure the observation object with structured detection, which is sensitive to the position deviation, while detecting the position deviation of the flow line.

In the flow cytometers 1, 1i, and 1j according to the above-described embodiments, the information generation device (the information generation unit 80 in each embodiment) generates optical information on the basis of the intensity of the optical signal emitted from the observation object (the cell C in each embodiment) when the illumination light (the structured illumination light SLE or SLEi in the first or second embodiment) that has undergone the structuring process is irradiated to the observation object (the cell C in each embodiment) flowing through the flow path 20 or the intensity of the optical signal (the structured optical signal SLSj in the third embodiment) that has undergone the structuring process.

According to this configuration, in the flow cytometers 1, 1i, and 1j according to each embodiment, in a case where the observation object flowing through the flow path 20 is irradiated with illumination light that has undergone a structuring process or a case where the illumination light is irradiated to the observation object and the optical signal emitted from the observation object undergoes a structuring process, the position x of the observation object in the width direction of the flow path 20 can be calculated. As such, it is possible to obtain the optical information of the observation object while detecting the position deviation of the flow line in these cases.

Moreover, in the flow cytometer 1j according to the present embodiment, the spatial light modulation unit 4j, which is installed on the optical path between the flow path 20 and the photodetector 6, is included to structure the optical signal LSj so that the intensity of the optical signal LSj emitted from the observation object (the cell C in the present embodiment) on the position detection lines (the first position detection line L1 and the second position detection line L2 in the present embodiment) is detected by the photodetector 6.

According to this configuration, in the flow cytometer 1 according to the present embodiment, the arrangement of the position detection line can be implemented by the structured detection for acquiring optical information. As such, the position detection line can be easily set on the flow path 20.

### Fourth Embodiment

Hereinafter, a fourth embodiment of the present invention will be described in detail with reference to the drawings.

In the first embodiment, the case where the flow cytometer measures the flow rate of the fluid flowing through the flow path and measures the position of the observation object in the width direction of the flow path using its value has been described. In the present embodiment, a case where a flow cytometer measures a position of an observation object in a width direction of a flow path without using any flow rate will be described. Also, in the present embodiment, a flow rate of a fluid flowing through the flow path is uniform.

The flow cytometer according to the present embodiment is referred to as a flow cytometer 1k and a calculation device is referred to as a calculation unit 81k.

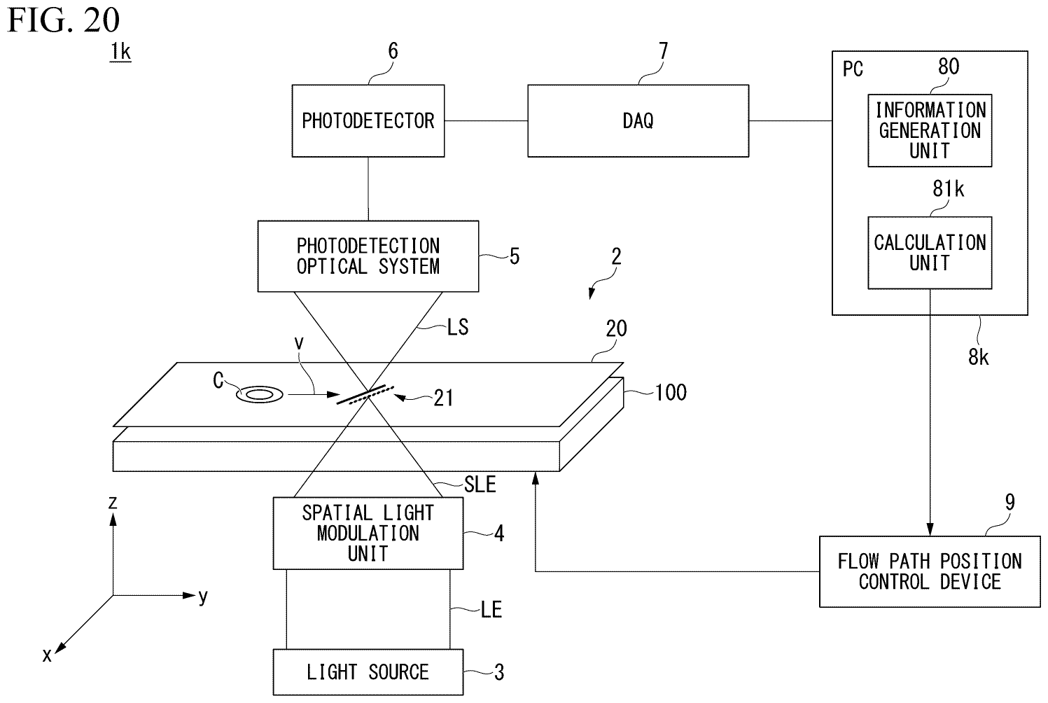

FIG. 20 is a diagram showing an example of the flow cytometer 1k according to the present embodiment. The flow cytometer 1k includes a microfluidic device 2, a light source 3, a spatial light modulation unit 4, a photodetection optical system 5, a photodetector 6, a DAQ device 7, a PC 8k, and a flow path position control device 9. When the flow cytometer 1k (FIG. 20) according to the present embodiment is compared with the flow cytometer 1 (FIG. 1) according to the first embodiment, the PC 8k is different. Here, functions of the other constituent elements (the microfluidic device 2, the light source 3, the spatial light modulation unit 4, the photodetection optical system 5, the photodetector 6, the DAQ device 7, and the flow path position control device 9) are the same as those of the first embodiment. Description of functions identical to those of the first embodiment will be omitted and parts different from those of the first embodiment will be mainly described in the fourth embodiment.

In the flow cytometer 1k, a position, which is a position x of a cell C in a width direction of a flow path 20, is measured without using any flow rate v. In the flow cytometer 1k, a position of an optical system is adjusted in advance so that the sensitivity of the optical system is maximized. The flow cytometer 1k measures in advance a time difference τ between the time when the cell C passes through a first position detection line L1 and the time when the cell C passes through a second position detection line L2 as a reference time difference τ0. The flow cytometer 1k measures the position x using a table showing a relationship between the deviation of the time difference τ from the reference time difference τ0 and the position x of the cell C in the width direction of the flow path 20. In the flow cytometer 1k, the time difference τ measured on the basis of the measured position x is compared with the reference time difference τ0 and the position of the flow path 20 is controlled so that deviation Δτ of the time difference τ from the reference time difference τ0 is reduced.

The reference time difference τ0 used here, for example, can be designated as the time difference τ between the time when the cell C has passed through the first position detection line L1 and the time when the cell C has passed through the second position detection line L2 when the cell C has moved on the flow line of the reference position described above. As another example of the reference time difference τ0, the time difference τ between the time when the cell C has passed through the first position detection line L1 and the time when the cell C has passed through the second position detection line L2 can be measured for a certain number of cells C and its average value can be set as the reference time difference τ0.

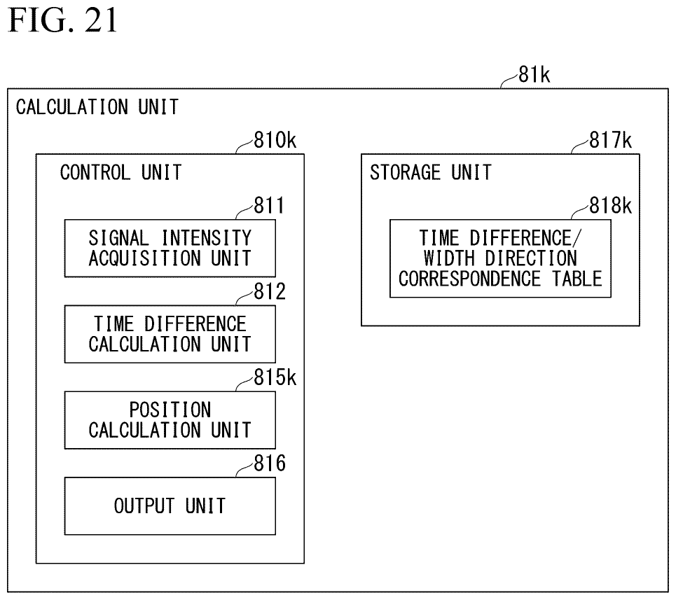

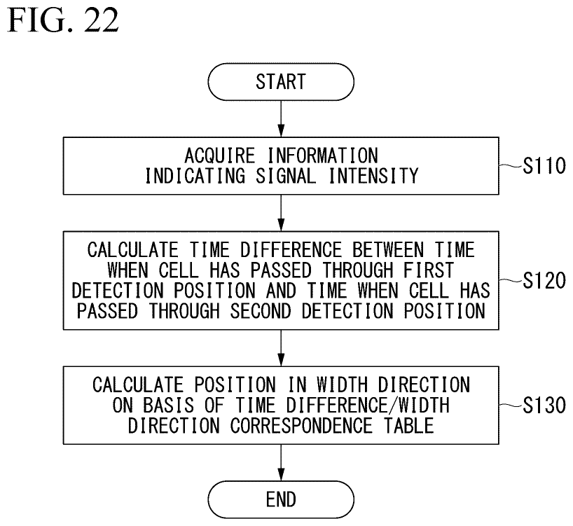

Next, details of the configuration and process of the calculation unit 81k will be described with reference to FIGS. 21 and 22. FIG. 21 is a diagram showing an example of the calculation unit 81k according to the present embodiment. The calculation unit 81k includes a control unit 810k and a storage unit 817k.

The control unit 810k includes a signal intensity acquisition unit 811, a time difference calculation unit 812, a position calculation unit 815k, and an output unit 816. When the control unit 810k (FIG. 21) according to the present embodiment is compared with the control unit 810 (FIG. 4) according to the first embodiment, they are different in that the position calculation unit 815k is provided and the flow rate calculation unit 813 and the position detection distance calculation unit 814 are omitted. Here, functions of the other constituent elements (the signal intensity acquisition unit 811, the time difference calculation unit 812, and the output unit 816) are the same as those of the first embodiment. Description of functions identical to those of the first embodiment will be omitted and parts different from those of the first embodiment will be mainly described in the fourth embodiment.

The position calculation unit 815k calculates the position of the observation object in the width direction on the basis of a corresponding relationship between the time difference τ calculated by the time difference calculation unit 812 and the position x of the cell C in the width direction of the flow path 20. That is, in the present embodiment, the position x of the cell C in the width direction of the flow path 20 is calculated on the basis of a time difference/width direction correspondence table 818k that is a table indicating a corresponding relationship between deviation Δτ of the time difference τ from the reference time difference τ0 and the position x of the cell C in the width direction of the flow path 20.

The storage unit 817k stores the time difference/width direction correspondence table 818k. As an example, the time difference/width direction correspondence table 818k is two-dimensional tabular data consisting of rows and columns in which the value of the position x of the cell C in the width direction of the flow path 20 is stored for each deviation Δτ of the time difference τ from the reference time difference τ0.

Here, the time difference/width direction correspondence table 818k is created on the basis of the pre-measurement results of the deviation Δτ of the time difference τ from the reference time difference τ0 and the position x of the cell C in the width direction of the flow path 20. Also, the measurement of the position x performed in advance may be performed on the basis of the method of the first embodiment based on the flow rate v described above, or may be performed on the basis of other measurement methods.

FIG. 22 is a diagram showing an example of a position calculation process according to the present embodiment. Because the processing of steps S110 and S120 is similar to the processing of steps S10 and S20 in FIG. 5, description thereof will be omitted.

Step S130: The position calculation unit 815k calculates the position x of the cell C in the width direction of the flow path 20 on the basis of the deviation Δτ of the time difference τ calculated by the time difference calculation unit 812 from the reference time difference τ0 and the time difference/width direction correspondence table 818k. Here, the position calculation unit 815k reads a value of the position in the width direction of the flow path 20 corresponding to the deviation Δτ from the time difference/width direction correspondence table 818k. The position calculation unit 815k sets the read position value as the position x of the cell C in the width direction of the flow path 20. In other words, the position calculation unit 815k calculates the position x by converting the deviation Δτ into the position in the width direction of the flow path 20 on the basis of the time difference/width direction correspondence table 818k.

Although an example in which the deviation Δτ of the time difference τ from the reference time difference τ0 is measured for one cell flowing through the flow path and the position of the flow path is corrected with respect to the position deviation of the flow line has been described in the present embodiment, the present invention is not limited thereto. On the basis of a result of measuring a position of each cell in the width direction of the flow path for a plurality of cells flowing through the flow path, the position of the flow path may be corrected for the position deviation of the flow line.

For example, it is assumed that 1000 cells C pass through the flow path 20 in one minute. For each of the 1000 cells C, the flow cytometer 1k measures the position x every time the cell C passes through the position detection line L for measuring the position x of the cell C in the width direction of the flow path 20. That is, the flow cytometer 1k measures the position x 1000 times. The flow cytometer 1k corrects the position of the flow path once per minute on the basis of 1000 measurement results of the position x.

The flow cytometer 1k corrects the position of the flow path on the basis of an average value of the 1000 measurement results of the position x. By correcting the position of the flow path using an average value of a plurality of measurement results, it is possible to correct a flow path position in consideration of the variation of the deviation Δτ of the time difference τ from the reference time difference τ0 in the calculation of the position x of the cell C in the width direction of the flow path 20 and suppress an influence of the variation. Moreover, by continuously correcting the position of the flow path, it is possible to appropriately correct the position deviation of the flow line due to the changes occurring with the passage of measurement time in the microfluidic device and minimize an influence of the position deviation.

According to the measurement method described above, the position deviation of the flow line can be reduced to less than or equal to the pixel size. Here, the pixel size is a few micrometers.

As described above, the flow cytometer 1k according to the present embodiment includes the position calculation unit 815k. The position calculation unit 815k calculates the position x of the observation object (the cell C in the present embodiment) in the width direction of the flow path 20 on the basis of a difference (the deviation Δτ in the present embodiment) of the time difference τ calculated by the time difference calculation unit 812 from a predetermined value (the reference time difference τ0 in the present embodiment) and a table (the time difference/width direction correspondence table 818k in the present embodiment) indicating a corresponding relationship between the difference (the deviation Δτ in the present embodiment) of the time difference τ from the predetermined value (the reference time difference τ0 in the present embodiment) and the position x of the observation object (the cell C in the present embodiment) in the width direction of the flow path 20.

According to this configuration, in the flow cytometer 1k according to the present embodiment, when the flow rate v of the fluid flowing through the flow path 20 is uniform, because it is possible to calculate the position x of the observation object (the cell C in the present embodiment) in the width direction of the flow path 20 from the time difference τ on the basis of the table (the time difference/width direction correspondence table 818k in the present embodiment) indicating the corresponding relationship between the difference (the deviation Δτ in the present embodiment) of the time difference τ from the predetermined value (the reference time difference τ0 in the present embodiment) and the position x of the cell C in the width direction of the flow path 20, it is possible to correct the position of the flow path with respect to the position deviation of the flow line on the basis of the time difference τ between the times when the cell C has passed through the first position detection line L1 and the second position detection line L2 and a corresponding relationship between the time difference τ and the position in the width direction without measuring the flow rate v of the fluid flowing through the flow path 20. Therefore, it is possible to perform measurement by minimizing the influence of position deviation of the flow line according to a simple configuration as compared with the case where three or more position detection lines are arranged.

Also, the flow cytometer according to each of the above-described embodiments may include a function of a cell sorter. The flow cytometer sorts cells on the basis of information indicating the cellular morphology included in the optical information generated by the information generation device (the information generation unit 80). Sorting is to separate predetermined cells from among the observation objects flowing through the flow path. This predetermined cell, for example, is pre-selected by a user.

Also, the flow cytometer according to each of the above-described embodiments may be provided as a part of the imaging device in combination with the image generation device. The image generation device includes an image generation unit that generates an image of an observation object (the cell C) on the basis of optical information generated by the information generation device (the information generation unit 80).

### Fifth Embodiment

Hereinafter, a fifth embodiment of the present invention will be described in detail with reference to the drawings.

In the present embodiment, a case where a cell flowing through a flow path is discriminated on the basis of optical information generated by an information generation device will be described. In the present embodiment, a width direction of a flow path 20 is also referred to as a horizontal direction. Also, in the present embodiment, a direction of an optical axis OX of an image-forming lens 50 (not shown) included in a photodetection optical system 5 on the flow path 20 is referred to as an optical axis direction. The direction of the optical axis OX is a direction of depth of the flow path. Moreover, a position of the cell C in a horizontal direction and a position of the cell C in a direction of an optical axis are referred to as a horizontal position and an optical axis position, respectively. The horizontal position is the same as a position x in a width direction of the flow path 20.

The flow cytometer according to the present embodiment is referred to as a flow cytometer 1m and the calculation unit is referred to as a calculation unit 81m. As an example, the configuration of the flow cytometer 1m is similar to the configuration of the flow cytometer 1 according to the first embodiment described above, except that the calculation unit 81m is different. Description of functions identical to those of the first embodiment will be omitted and parts different from those of the first embodiment will be mainly described in the fifth embodiment. Also, the configuration of the flow cytometer 1m may be similar to the configuration of the flow cytometer according to the modified example of the first embodiment and the second, third, and fourth embodiments in relation to constituent elements other than the calculation unit 81m.

### [Calculation Device]

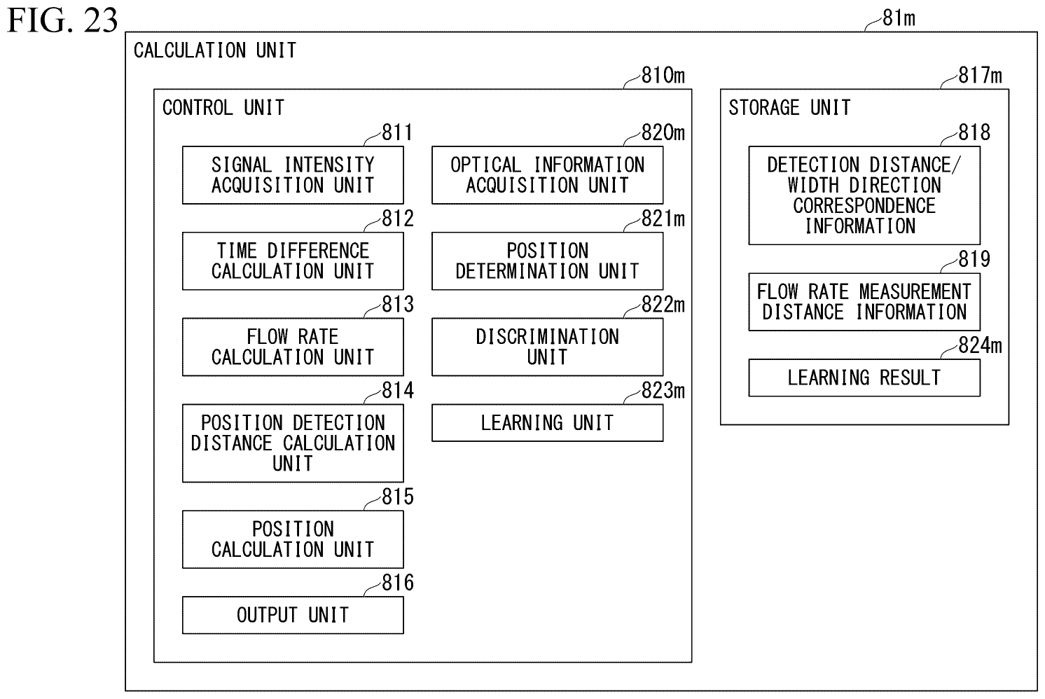

FIG. 23 is a diagram showing an example of a configuration of the calculation unit 81m according to the present embodiment. When the calculation unit 81m (FIG. 23) according to the present embodiment is compared with the calculation device 10 (FIG. 4) according to the first embodiment, an optical information acquisition unit 820m, a position determination unit 821m, a discrimination unit 822m, a learning unit 823m, and a storage unit 817m are different. Here, functions of the other constituent elements (a signal intensity acquisition unit 811, a time difference calculation unit 812, a flow rate calculation unit 813, a position detection distance calculation unit 814, a position calculation unit 815, and an output unit 816) are the same as those of the first embodiment.

In addition to the signal intensity acquisition unit 811, the time difference calculation unit 812, the flow rate calculation unit 813, the position detection distance calculation unit 814, the position calculation unit 815, and the output unit 816, the control unit 810m includes the optical information acquisition unit 820m, the position determination unit 821m, the discrimination unit 822m, and the learning unit 823m.

The optical information acquisition unit 820m acquires optical information IC generated by the PC 8.

The position determination unit 821m determines whether or not the position x (horizontal position) of the cell C in the width direction of the flow path 20 output by the output unit 816 is within a predetermined range with respect to the width direction of the flow path 20. Also, in the following description, information indicating a position x (horizontal position) of the cell C in the width direction of the flow path 20 is referred to as position information IP.

The discrimination unit 822m learns a relationship between cells for learning and the optical information IC about the cells for learning and discriminates the cell C on the basis of the created inference model and the optical information IC generated by the PC 8. At this time, the discrimination unit 822m designates the cells C flowing through an area Z1, which is a predetermined range in a horizontal position of the flow path 20, as discrimination targets on the basis of a determination result of the position determination unit 821m.

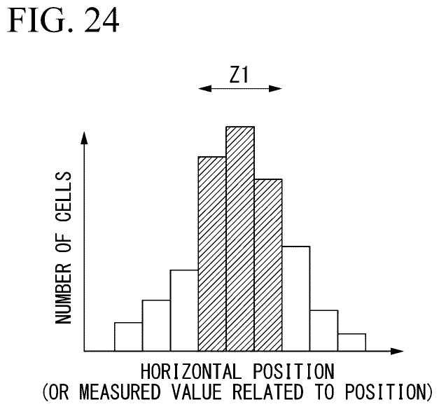

Here, the above-described area Z1 will be described with reference to FIG. 24. FIG. 24 is a diagram showing an example of the area Z1 according to the present embodiment. FIG. 24 is a histogram showing the number of the cells C whose measured values of the horizontal positions are included in a predetermined interval by each predetermined interval. In that case, for each cell C passing through the flow path 20, the horizontal position where it passes through the flow path 20 is measured and the range of possible values for the horizontal position in the flow path 20 is segmented into predetermined intervals. The discrimination unit 822m designates the optical information IC of the cells C corresponding to the measured values passing through the range of intervals included in the area Z1, among the cells C passing through the flow path 20, as the discrimination target.

The area Z1 is, for example, a line segment ranging up to intervals including positions deviated by a predetermined distance from an initial passage position of the cell C in the horizontal position of the flow path 20.

Also, instead of directly using the measured value of the horizontal position, the position determination unit 821m may determine whether or not the cell C flowing through the flow path 20 is included in the area corresponding to the area Z1 on the basis of a measured value of an amount related to the horizontal position.

Description of the configuration of the calculation unit 81m will continue with reference back to FIG. 23.

The learning unit 823m executes machine learning. The learning unit 823m learns a relationship between the cells for learning and the optical information obtained in measurement using the cells for learning. As an example, the machine learning executed by the learning unit 823m is deep learning.

The cells for learning are the cells C flowing within the area Z1. In the present embodiment, the cells C are measured using a flow cytometer 1m and machine learning is executed using the measured values of the cells C flowing within the area Z1 of the flow path 20 at the time of measurement as training data.

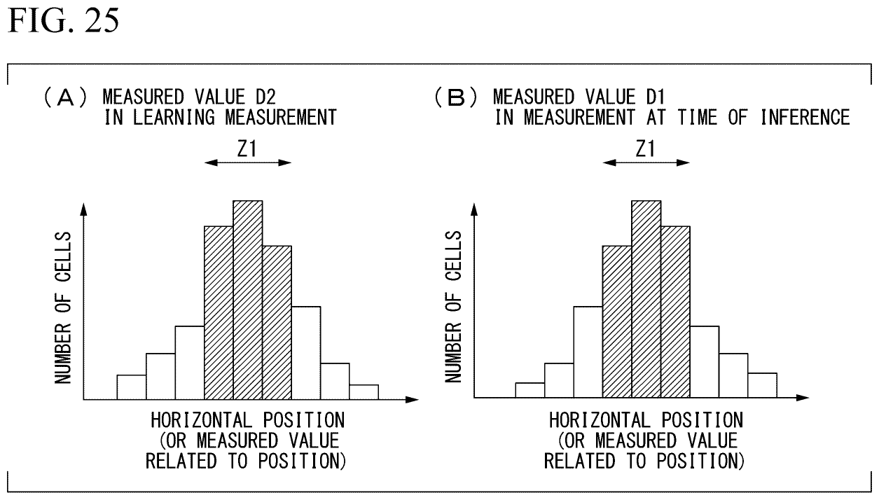

Here, the area Z1 for the cells for learning described above will be described with reference to FIG. 25. FIG. 25 is a diagram showing an example of the area Z1 of the cells for learning according to the present embodiment. FIG. 25(A) is a histogram showing the number of the cells C whose measured values of the horizontal position are included in a predetermined interval by each predetermined interval. In that case, horizontal positions through which the cells pass are measured when the measurement for learning is performed using the flow cytometer 1m and the range of possible value for the horizontal positions in the flow path is segmented into the predetermined intervals. For comparison, FIG. 25(B) shows a histogram showing the number of cells C whose measured values of the horizontal position are included in a predetermined interval by each predetermined interval. In that case, horizontal positions through which the cells C pass are measured at the time of inference of machine learning and the range of the possible value for the horizontal positions in the flow path is segmented into the predetermined intervals.

In the present embodiment, the cells for learning used in a learning process of the learning unit 823m is the cells C flowing within the area Z1. This area Z1 is the same as the area Z1 through which the cells C designated as the discrimination target by the discrimination unit 822m flows at the time of inference. That is, the cells for learning are the cells C flowing in the same area Z1 as the area Z1 through which the cells C designated by the discrimination unit 822m as the discrimination target flow.

Description of the configuration of the calculation unit 81m will continue with reference back to FIG. 23.

The storage unit 817m stores various information. The information stored in the storage unit 817m includes a learning result 824m. The learning result 824m is a result of learning performed by the learning unit 823m. The learning result 824m is the inference model described above. The learning result 824m is stored in the storage unit 817m by performing learning in advance.

### [Cell Discrimination Process]

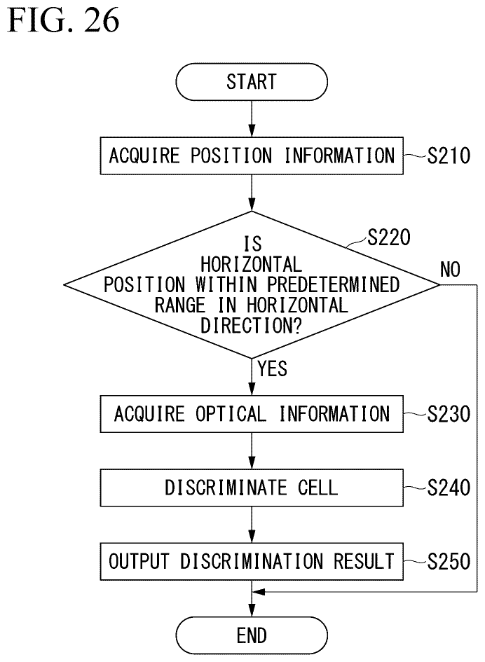

Next, a cell discrimination process, which is a process in which the calculation unit 81m discriminates a cell C, will be described with reference to FIG. 26. FIG. 26 is a diagram showing an example of the cell discrimination process according to the present embodiment. The cell discrimination process shown in FIG. 26 is executed for one cell C. The cell discrimination process executed for a plurality of cells flowing through the flow path 20 is iteratively executed for a plurality of cells using the cell discrimination process shown in FIG. 26 as one unit.

Step S210: The position determination unit 821m acquires position information IP output by the output unit 816. Here, the position information IP indicates the horizontal position of the cell C.

Step S220: The position determination unit 821m determines whether or not the horizontal position of the cell C indicated in the position information IP output by the output unit 816 is within an area Z1 that is a predetermined range in the width direction of the flow path 20.

When the position determination unit 821m determines that the horizontal position is within the area Z1 in the width direction of the flow path 20 (step S220; YES), the control unit 810m executes the processing of step S230. On the other hand, when the position determination unit 821m determines that the horizontal position is not within the area Z1 in the width direction of the flow path 20 (step S220; NO), the control unit 810m ends the cell discrimination process.

Step S230: The optical information acquisition unit 820m acquires optical information IC generated by the PC 8. The optical information acquisition unit 820m supplies the acquired optical information IC to the discrimination unit 822m.

Step S240: The discrimination unit 822m discriminates the cell C on the basis of the learning result 824m and the optical information IC generated by the PC 8. As described above, the learning result 824m is the result of learning the relationship between the cells for learning and the optical information for the cells for learning. For example, when deep learning is used as machine learning, the learning result 824m indicates a neural network that has been trained to output the type of cell when the optical information is input.

The discrimination unit 822m inputs the optical information IC generated by the PC 8 to the neural network indicated as the learning result 824m. The discrimination unit 822m determines whether or not the type of cell output by the neural network, which is indicated as the learning result 824m, is a desired type of cell.

The processing of step S240 is executed when the position determination unit 821m determines that the horizontal position is within the area Z1 in the width direction of the flow path 20 in the processing of step S220. That is, the discrimination unit 822m designates a cell C flowing within an area Z1 that is a predetermined range as a discrimination target on the basis of a determination result of the position determination unit 821m.

Step S250: The discrimination unit 822m outputs a discrimination result to an external device via the output unit 816. Here, the external device is, for example, an isolation unit that isolates cells C. When the flow cytometer 1m includes the isolation unit, the flow cytometer 1m functions as a cell sorter.

As described above, the calculation device 10 ends the cell discrimination process.

Although an example in which the learning unit 823m is provided in the calculation unit 81m and the calculation device 10 executes machine learning has been described in the present embodiment, the present invention is not limited thereto. Machine learning may be executed by an external device. When machine learning is executed by an external device, the calculation unit 81m acquires a machine learning result from the external device, causes the storage unit 817m to store the learning result, and uses the machine learning result for a cell discrimination process.

### [Summary of Fifth Embodiment]

As described above, in the flow cytometer 1m according to the present embodiment, the calculation device (the calculation unit 81m in the present embodiment) includes the discrimination unit 822m and the position determination unit 821m.

The discrimination unit 822m discriminates the observation object (the cell C in the present embodiment) on the basis of the optical information IC generated by the information generation device (the information generation unit 80 in the present embodiment).

The position determination unit 821m determines whether or not the position x in the width direction of the flow path 20 calculated by the position calculation unit 815 is within a predetermined range (the area Z1 in the present embodiment) in the width direction of the flow path 20.

On the basis of the determination result of the position determination unit 821m, the discrimination unit 822m designates the observation object (the cell C in the present embodiment) flowing within the predetermined range (the area Z1 in the present embodiment) as a discrimination target.

According to this configuration, in the flow cytometer 1m according to the present embodiment, because an observation object flowing within a predetermined range in the flow path 20 can be designated as the discrimination target, it is possible to reduce the dependence of an analysis result (the optical information IC) for discriminating the observation object on the position deviation of the flow line. In the flow cytometer 1m according to the present embodiment, it is possible to perform gating on the basis of the position x in the width direction of the flow path 20 and implement more robust data analysis than when no gating is performed.

Moreover, in the flow cytometer 1m according to the present embodiment, the discrimination unit 822m discriminates the observation object (the cell C in the present embodiment) on the basis of an inference model (the learning result 824m in the present embodiment) created by learning a relationship between a learning observation object (the cell for learning in the present embodiment) and optical information for the learning observation object (the cell for learning in the present embodiment) and the optical information IC generated by the information generation device (the information generation unit 80 in the present embodiment).

Moreover, the learning observation object (the cell for learning in the present embodiment) is the observation object (the cell in the present embodiment) flowing within a predetermined range (the area Z1 in the present embodiment).

According to this configuration, in the flow cytometer 1m according to the present embodiment, because it is possible to perform a discrimination process on the basis of the inference model (the learning result 824m in the present embodiment) created by learning the relationship between the observation objects flowing within the predetermined range and the optical information for the learning observation objects and it is possible to reduce an influence of the position deviation in the width direction of the flow line on the learning result 824m as compared with a case where the learning observation objects are not limited to the observation objects flowing within the predetermined range, it is possible to suppress the deterioration in the accuracy of machine learning based on the learning result 824m due to the position deviation of the flow line.

In addition, a part of each of the calculation units 81, 81k, and 81m in the above-described embodiment, for example, the time difference calculation unit 812, the flow rate calculation unit 813, the position detection distance calculation unit 814, and the position calculation units 815 and 815k, may be configured to be implemented in a computer. In this case, this control function may be implemented by recording a program for implementing the control function on a computer-readable recording medium and causing a computer system to read and execute the program recorded on the recording medium. In addition, the “computer system” used herein is assumed to include an operating system (OS) and hardware such as peripheral equipment in the computer system embedded in the calculation units 81 and 81k. Also, the “computer-readable recording medium” refers to a flexible disk, a magneto-optical disc, a read-only memory (ROM), a portable medium such as a compact disc (CD)-ROM, or a storage device such as a hard disk embedded in the computer system. Furthermore, the “computer-readable recording medium” may include a computer-readable recording medium for dynamically holding the program for a short time period as in a communication line when the program is transmitted via a network such as the Internet or a communication circuit such as a telephone circuit and a computer-readable recording medium for holding the program for a given time period as in a volatile memory inside the computer system serving as a server or a client when the program is transmitted. Also, the above-described program may be a program for implementing some of the above-described functions. Furthermore, the above-described program may be a program capable of implementing the above-described function in combination with a program already recorded on the computer system.

Also, some or all of the calculation units 81 and 81k in the above-described embodiments may be implemented as an integrated circuit such as a large-scale integration (LSI) circuit. Also, the functional blocks of the calculation units 81, 81k and 81m in the above-described embodiments may be individually constructed as processors or some or all functional blocks may be integrated and constructed as processors. Also, a method of forming an integrated circuit is not limited to an LSI circuit, but may be implemented with dedicated circuits or general-purpose processors. Also, in the case where the integrated circuit technology which is substituted for an LSI circuit appears due to the advance of the semiconductor technology, an integrated circuit based on the technology may be used.

Although embodiments of the present invention have been described in detail above with reference to the drawings, specific configurations are not limited to the embodiments and various design changes and the like can also be made without departing from the scope and spirit of the present invention.

### REFERENCE SIGNS LIST

1, li, 1j, 1m Flow cytometer

2 Microfluidic device

20, 20a, 20b, 20c, 20d, 20e, 20f, 20g, 20h Flow path

3 Light source

6 Photodetector

80 Information generation unit

81, 81k, 81m Calculation unit

9 Flow path position control device

L Position detection line

L1, L1a, L1b, L1c, L1d, L1e, L1f, L1g, L1h First position detection line

L2, L2a, L2b, L2c, L2d, L2e, L2f, L2g, L2h Second position detection line

812 Time difference calculation unit

815 Position calculation unit

1. A flow cytometer comprising:
a microfluidic device having a flow path through which an observation object can flow with a fluid,
a light source configured to irradiate illumination light to the flow path,
a photodetector configured to detect the intensity of an optical signal emitted from the observation object in a time series when the illumination light is irradiated to the observation object flowing through the flow path,
an information generation device configured to generate optical information indicating any one or more of a shape, form, and structure of the observation object on the basis of the intensity of the optical signal detected by the photodetector, and
a calculation device configured to calculate a position of the observation object in a width direction of the flow path on the basis of the time when the photodetector has detected a peak intensity of the optical signal,
wherein, in the microfluidic device,
a first position detection line, which is a group of a plurality of detection positions where the photodetector detects a position of the observation object and a position detection line having at least a length in the width direction, is arranged on the flow path,
a second position detection line serving as the position detection line is arranged with a portion overlapping the first position detection line in the width direction, and
a position detection distance, which is a distance between the first position detection line and the second position detection line in a length direction of the flow path, changes with a position in the width direction,
wherein the calculation device comprises:
a time difference calculation unit configured to calculate a time difference between the time when the photodetector has detected the peak intensity of the optical signal at any one detection position on the first position detection line and the time when the photodetector has detected the peak intensity of the optical signal at any one detection position on the second position detection line; and
a position calculation unit configured to calculate the position of the observation object in the width direction on the basis of the time difference calculated by the time difference calculation unit and a corresponding relationship between the time difference and the position in the width direction.

2. The flow cytometer according to claim 1, further comprising a flow path position control device configured to control a position of the flow path on the basis of a calculation result of the calculation device.

3. The flow cytometer according to claim 1,
wherein a third position detection line serving as the position detection line is arranged on the flow path,
wherein a fourth position detection line serving as the position detection line approximately parallel to the third position detection line is arranged at a flow rate measurement distance, which is a predetermined distance from the third position detection line, and has a portion overlapping the third position detection line in the width direction, and
wherein the calculation device further comprises
a flow rate calculation unit configured to calculate a flow rate of the fluid on the basis of the time when the photodetector has detected the peak intensity of the optical signal at any one detection position on the third position detection line, the time when the photodetector has detected the peak intensity of the optical signal at any one detection position on the fourth position detection line, and the flow rate measurement distance; and
a position detection distance calculation unit configured to calculate the position detection distance corresponding to the position of the observation object in the width direction on the basis of the time difference calculated by the time difference calculation unit and the flow rate calculated by the flow rate calculation unit.

4. The flow cytometer according to claim 1, further comprising a spatial light modulation unit installed on an optical path between the light source and the photodetector and configured to structure either the illumination light or the optical signal.

5. The flow cytometer according to claim 4, wherein the light source irradiates the illumination light structured by the spatial light modulation unit installed on the optical path between the light source and the flow path to the flow path.

6. The flow cytometer according to claim 4, wherein the photodetector detects the intensity of the optical signal in a time series when the optical signal is structured by the spatial light modulation unit arranged on the optical path between the flow path and the photodetector.

7. The flow cytometer according to claim 1, wherein the position detection distance changes monotonically with the position in the width direction in relation to the position detection lines.

8. The flow cytometer according to claim 1, wherein the position detection line is a straight line.

9. The flow cytometer according to claim 8, wherein an angle between the first position detection line and the second position detection line is greater than or equal to a predetermined value.

10. The flow cytometer according to claim 5, wherein the position detection line is arranged according to the illumination light structured by the spatial light modulation unit.

11. The flow cytometer according to claim 6, wherein the position detection line is arranged according to the optical signal structured by the spatial light modulation unit.

12. The flow cytometer according to claim 1, wherein the calculation device further comprises:
a discrimination unit configured to discriminate the observation object on the basis of the optical information generated by the information generation device; and
a position determination unit configured to determine whether or not the position in the width direction calculated by the position calculation unit is within a predetermined range in the width direction, and
wherein the discrimination unit designates the observation object flowing within the predetermined range as a discrimination target on the basis of a determination result of the position determination unit.

13. The flow cytometer according to claim 12,
wherein the discrimination unit discriminates the observation object on the basis of an inference model created when a relationship between a learning observation object and optical information for the learning observation object is learned and the optical information generated by the information generation device, and
wherein the learning observation object is an observation object flowing within the predetermined range.

14. An imaging device comprising:
the flow cytometer according to claim 1; and
an image generation device comprising an image generation unit configured to generate an image of the observation object on the basis of the optical information generated by the information generation device.

15. A method of calculating a position of an observation object in a width direction in a flow cytometer including
a microfluidic device having a flow path through which the observation object can flow with a fluid,
a light source configured to irradiate illumination light to the flow path,
a photodetector configured to detect the intensity of an optical signal emitted from the observation object in a time series when the illumination light is irradiated to the observation object flowing through the flow path,
an information generation device configured to generate optical information indicating any one or more of a shape, form, and structure of the observation object on the basis of the intensity of the optical signal detected by the photodetector, and
a calculation device configured to calculate the position of the observation object in the width direction of the flow path on the basis of the intensity of the optical signal detected by the photodetector, the method comprising:
a time difference calculation process of calculating a time difference between the time when the photodetector has detected the peak intensity of the optical signal at any one detection position on a first position detection line, which is arranged on the flow path and is a group of a plurality of detection positions where the photodetector detects the position of the observation object and a position detection line having at least a length in the width direction, and the time when the photodetector has detected the peak intensity of the optical signal at any one detection position on a second position detection line serving as the position detection line arranged with a portion overlapping the first position detection line in the width direction, wherein a position detection distance, which is a distance between the first position detection line and the second position detection line in a length direction of the flow path, changes with a position in the width direction; and
a position calculation process of calculating the position of the observation object in the width direction on the basis of the time difference calculated in the time difference calculation process and a corresponding relationship between the time difference and the position in the width direction.

16. A program for causing a computer, which calculates a position of an observation object in a width direction in a flow cytometer comprising
a microfluidic device having a flow path through which the observation object can flow with a fluid,
a light source configured to irradiate illumination light to the flow path,
a photodetector configured to detect the intensity of an optical signal emitted from the observation object in a time series when the illumination light is irradiated to the observation object flowing through the flow path,
an information generation device configured to generate optical information indicating any one or more of a shape, form, and structure of the observation object on the basis of the intensity of the optical signal detected by the photodetector, and
a calculation device configured to calculate the position of the observation object in the width direction of the flow path on the basis of the intensity of the optical signal detected by the photodetector, to execute:
a time difference calculation step of calculating a time difference between the time when the photodetector has detected the peak intensity of the optical signal at any one detection position on a first position detection line, which is arranged on the flow path and is a group of a plurality of detection positions where the photodetector detects the position of the observation object and a position detection line having at least a length in the width direction, and the time when the photodetector has detected the peak intensity of the optical signal at any one detection position on a second position detection line serving as the position detection line arranged with a portion overlapping the first position detection line in the width direction, wherein a position detection distance, which is a distance between the first position detection line and the second position detection line in a length direction of the flow path, changes with a position in the width direction; and
a position calculation step of calculating the position of the observation object in the width direction on the basis of the time difference calculated in the time difference calculation step and a corresponding relationship between the time difference and the position in the width direction.
